(19) United States
(12) Patent Application Publication
(10) Pub. No.: US 2017/0075528 A1
(43) Pub. Date: Mar. 16, 2017

(54) METHOD AND ELECTRONIC DEVICE FOR TAB NAVIGATION AND CONTROL

(71) Applicant: Samsung Electronics Co., Ltd., Suwon-si (KR)

(72) Inventors: Divya KOTHARI, Noida (IN); Arohi SINGHAL, Noida (IN); Nisha DAWAR, Noida (IN)

(21) Appl. No.: 15/261,284

(22) Filed: Sep. 9, 2016

(30) Foreign Application Priority Data
Sep. 11, 2015 (IN) 2859/DEL/2015

(51) Int. Cl. G06F 3/0483; G06F 3/0482

(52) U.S. Cl. CPC G06F 3/0483; G06F 3/0482

(57) ABSTRACT

A centralized tab management method to access, navigate, and control various tab functionality of a tabbed user interfaces is provided. In response to detecting opening of multiple tabs in an application, tab pane information corresponding to a plurality of data files rendered by the opened tabs is extracted. A tab pane is created and the tab pane information thus extracted is displayed. The tab pane is displayed in the form of a sub-window, a new tab, an overlay, a pop-up, a side bar in the application. Additionally, a function on one or more data files is controlled based on actuation of a corresponding functionality on the tab pane.

### CROSS-REFERENCE TO RELATED APPLICATION(S)

This application claims the benefit under 35 U.S.C. §119(a) of an Indian patent application filed on Sep. 11, 2015 in the Indian Patent Office and assigned Serial No. 2859/DEL/2015, the entire disclosure of which is hereby incorporated by reference.

### TECHNICAL FIELD

The present disclosure relates to the area of navigation and function invoking through tabbed user interfaces.

### BACKGROUND

A web browser is a software application used to locate, retrieve and display content on the World Wide Web, including hypertext markup language (HTML) web pages, images, JavaScript, video and other files hosted on web servers. As a client/server model, the browser is the client run on a computer that contacts the web server and requests information. The web server sends the information back to the web browser which displays the results on the computer or other Internet-enabled device that supports a browser.

Some popular web browsers include Internet Explorer, Firefox, Apple Safari and Google Chrome. The web browser application has a user interface (UI) consisting of features like back, forward, refresh, home, address bar, search bar, viewport, settings. The UI works over the layout engine, UI backend, networking component and data persistence component. Layout engine or web browser engine is the heart of the web browser that takes marked up content (such as HTML, extensible markup language (XML), image files, etc.) and formatting information (such as cascading style sheets (CSS), extensible stylesheet language (XSL), etc.) and displays the formatted content on the screen.

The primary purpose of a web browser is to bring information resources to the user (“retrieval” or “fetching”), allowing them to view the information (“display”, “rendering”), and then access other information (“navigation”, “following links”). This process begins when the user inputs a uniform resource locator (URL), for example http://en.wikipedia.org/, into the browser. The prefix of the URL, the uniform resource identifier (URI) or http://en.wikipedia.org/wiki/URIURI, determines how the URL will be interpreted. The most commonly used kind of URI starts with http: and identifies a resource to be retrieved over the hypertext transfer protocol (HTTP).

A modern web browser has multiple features; tabbed browsing being one of them. Tabbed browsing enables a user to open multiple websites in a single browser window. The user can open web pages in new tabs, and switch between them by clicking the tabs he/she want to view. While tabbed user interfaces provide numerous practical advantages, it becomes increasingly difficult for the user to navigate to each tab and find a particular tab of interest.

In addition to web browser, many applications also provide the tabbed content viewing of the data file. In an application offering a tabbed user interface, a user can open multiple tabs within a single window. After opening each of these tabs, the user can then navigate to a particular opened tab by manual selection of the tab. When the tab is selected (as an “active tab”), the respective data file is displayed to the user in the window as the “active content” while other opened data files, associated with unselected tabs (“inactive tabs”), are hidden from the user's view as an “inactive data files”.

While tabbed user interfaces provide a number of advantages, still when the number of opened webpages increases in a window, it becomes increasingly difficult for the user to find a particular tab of interest. For example, consider a user searching a university for a Master of Business Administration (MBA). This user may use a tabbed web browser to peruse multiple web pages to find information of interest. Once information of interest is found in six or more tabs, the user may need to frequently switch between tabs to find more relevant information. As such, the user is likely to find it increasingly difficult to keep track of a specific tab(s) of interest, and navigate between them. Moreover, it is cumbersome to find particular keyword(s) of interest in all opened Tabs or on selective tabs by individual searching in each tab one by one. It is difficult to control (i.e. bookmark, pin, etc.) 5-6 tabs at a time without actual navigation on each tab.

Thus, in the current version of applications (including web browser) that provide tabbed content viewing, when n number of tabs are open, one of the challenges faced is in terms of content searching Finding relevant content is difficult and a user has to go to each individual tab to know its content. Yet another challenge is the navigation and maintaining of the hierarchy, both of which have to be done manually. Also, invoking functionality on a particular tab requires manual navigation to the tab, followed by multiple operations to invoke the functionality. By way of example, consider a scenario wherein the user wishes to print content of a particular tab. To invoke this simple function, the user must navigate to the appropriate tab and then perform a series of operations.

Thus, there is a need to provide a centralized tab management method to access, navigate, and control various tab functionality.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a centralized tab management method to access, navigate, and control various tab functionality of a tabbed user interfaces.

In accordance with an aspect of the present disclosure, tab pane information is extracted corresponding to a plurality of data files rendered by the tabs opened in the application. A tab pane is created and the tab pane information thus extracted is displayed. Additionally, a function corresponding to the data file as rendered in an opened tab is linked to a function on the tab pane such that invoking the function on the tab pane results in execution of the linked function on one or more data files as rendered in the tabbed user interfaces within the application.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a flowchart of a centralized navigation method according to an embodiment of the present disclosure;

FIGS. 2A and 2B illustrate a flowchart of a centralized navigation method according to various embodiments of the present disclosure;

FIG. 3 illustrates a flowchart of a summarization method using meta data and title according to an embodiment of the present disclosure;

FIG. 4 illustrates a flowchart of a summarization method using keywords according to an embodiment of the present disclosure;

FIG. 5 illustrates a flowchart of a summarization method using sentence extraction according to an embodiment of the present disclosure;

FIG. 6 illustrates a flowchart of a summarization method using extraction according to an embodiment of the present disclosure;

FIG. 7 illustrates a flowchart of a summarization method using unsupervised key phrase extraction according to an embodiment of the present disclosure;

FIG. 8 illustrates a flowchart of a cohesive summary summarization method according to an embodiment of the present disclosure;

FIG. 9 illustrates a screen shot of a browser interface rendering a sub-window tab pane according to an embodiment of the present disclosure;

FIG. 10 illustrates a screen shot of a browser interface rendering an overlay tab pane according to an embodiment of the present disclosure;

FIG. 11 illustrates a screen shot of a browser interface rendering a pop-up window tab pane according to an embodiment of the present disclosure;

FIG. 12 illustrates a screen shot of a browser interface rendering a tab pane in a form of a fresh tab according to an embodiment of the present disclosure;

FIG. 13 illustrates a screen shot of a browser interface rendering a side-bar tab pane according to an embodiment of the present disclosure;

FIGS. 14A and 14B illustrate screen shots of navigation using a tab pane according to various embodiments of the present disclosure;

FIG. 15 illustrates a screen shot of a browser interface rendering tab pane, with the tab pane comprising grouped tab pane information according to an embodiment of the present disclosure;

FIGS. 16A and 16B illustrate screen shots of re-arranging tab pane information within a tab pane and a resultant re-arranging of tabs within a multi-tabbed browser interface according to various embodiments of the present disclosure;

FIGS. 17A and 17B illustrate screen shots of a re-arranging of tab pane information within a tab pane and a resultant re-arranging of tabs within a multi-tabbed browser interface according to various embodiments of the present disclosure;

FIG. 18 illustrates a screen shot showing tab pane information pertaining to different data files being displayed in a visually differentiated manner according to an embodiment of the present disclosure;

FIGS. 19A and 19B illustrate screen shots showing removal of duplicate tab pane information and closing of a duplicate tab according to various embodiments of the present disclosure;

FIG. 20 illustrates a shot showing re-sizing and re-location of a tab pane according to an embodiment of the present disclosure;

FIG. 21 illustrates a flowchart of a centralized control method according to an embodiment of the present disclosure;

FIG. 22 illustrates a screen shot of a browser interface rendering a tab pane with functionality control options according to an embodiment of the present disclosure;

FIG. 23 illustrates a screen shot of a browser interface rendering a tab pane with centralized functionality control options according to an embodiment of the present disclosure;

FIGS. 24A and 24B illustrate screen shots showing actuation of a pin-function on a tab pane and its effect according to various embodiments of the present disclosure;

FIG. 25 illustrates a screen shot showing performance of a search function using a centralized functionality control option as provided on a tab pane according to an embodiment of the present disclosure;

FIGS. 26A and 26B illustrate screen shots showing performance of a dockable summary tab function using a centralized functionality control option as provided on a tab pane and its effect according to various embodiments of the present disclosure;

FIGS. 27A and 27B illustrate screen shots showing performance of a pin-out function using a centralized functionality control option as provided on a tab pane and its effect according to various embodiments of the present disclosure;

FIGS. 28A, 28B, 28C, 28D and 28E illustrate screen shots showing performance of an add to bookmark function using a centralized functionality control option as provided on a tab pane and its effect according to various embodiments of the present disclosure;

FIGS. 29A and 29B illustrate screen shots showing performance of a batch-wise tab close function using a centralized functionality control option as provided on a tab pane and its effect according to various embodiments of the present disclosure;

FIG. 30 illustrates providing preview functionality on a common control tab pane according to an embodiment of the present disclosure;

FIG. 31 illustrates screen shots showing performance of an import/export function using a centralized functionality control option as provided on a tab pane and its effect according to an embodiment of the present disclosure;

FIGS. 32A and 32B illustrate screen shots showing performance of a sorting function using a centralized functionality control option as provided on a tab pane and its effect according to various embodiments of the present disclosure;

FIG. 33 illustrates a block diagram of a system for performing a centralized navigation method and a centralized control method according to an embodiment of the present disclosure;

FIGS. 34A and 34B illustrate block diagrams of an extraction module according to an embodiment of the present disclosure;

FIG. 35 illustrates a hardware configuration of a system in the form of a computer system according to an embodiment of the present disclosure;

FIG. 36 illustrates implementation of a method in a handheld device with user input being received via a stylus device according to an embodiment of the present disclosure;

FIG. 37 illustrates implementation of a method in a handheld device with user input being received via a touch screen according to an embodiment of the present disclosure;

FIG. 38 illustrates implementation of a method in a television with user input being received in the form of a gesture input according to an embodiment of the present disclosure; and

FIG. 39 illustrates implementation of a method in a television with user input being received in the form of a pointing action according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting.

Embodiments of the present disclosure will be described below in detail with reference to the accompanying figures.

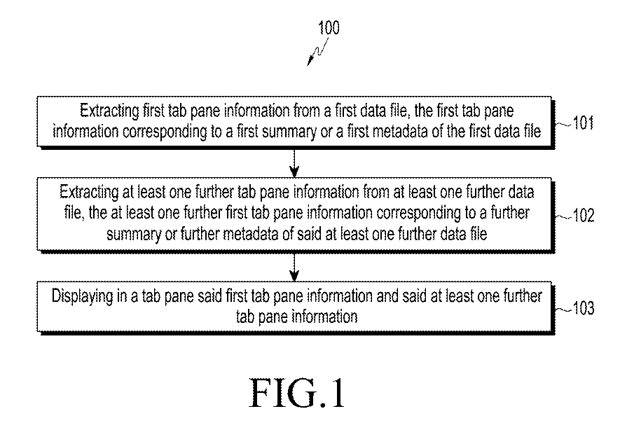

FIG. 1 illustrates a flowchart of a centralized navigation method according to an embodiment of the present disclosure.

Referring to FIG. 1, there is illustrated a method for enabling a centralized navigation (100), comprising the operations of extracting first tab pane information from a first data file at operation 101, the first tab pane information corresponding to a first summary or first metadata of the first data file and extracting at least one further tab pane information from at least one further data file at operation 102, the at least one further tab pane information corresponding to a further summary or further metadata of the at least one further data file. The centralized navigation method further comprises displaying in a tab pane, the first tab pane information and the at least one further tab pane information at operation 103.

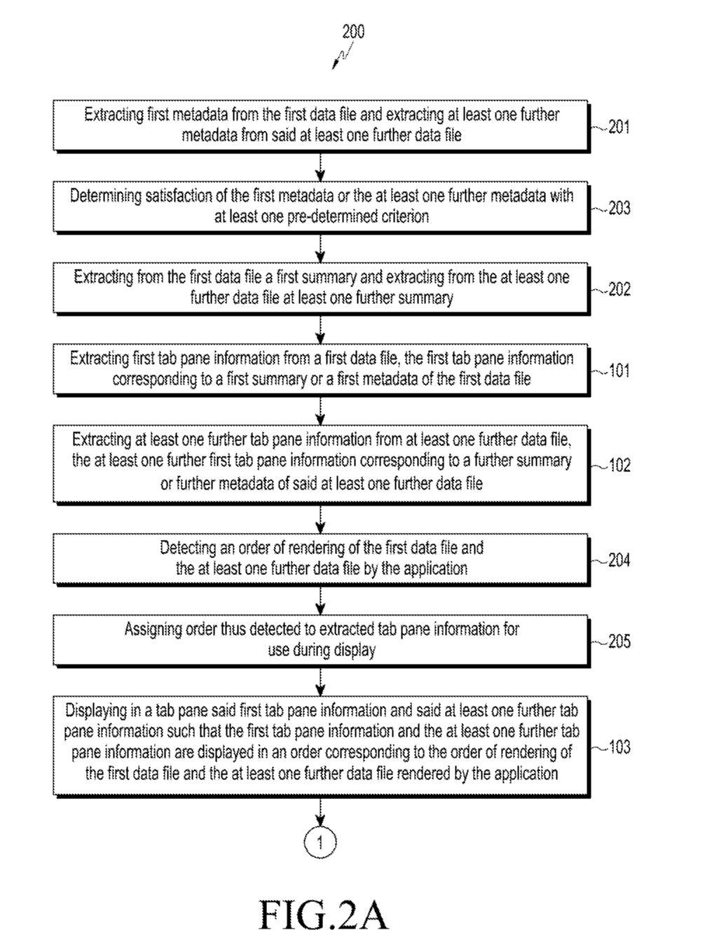

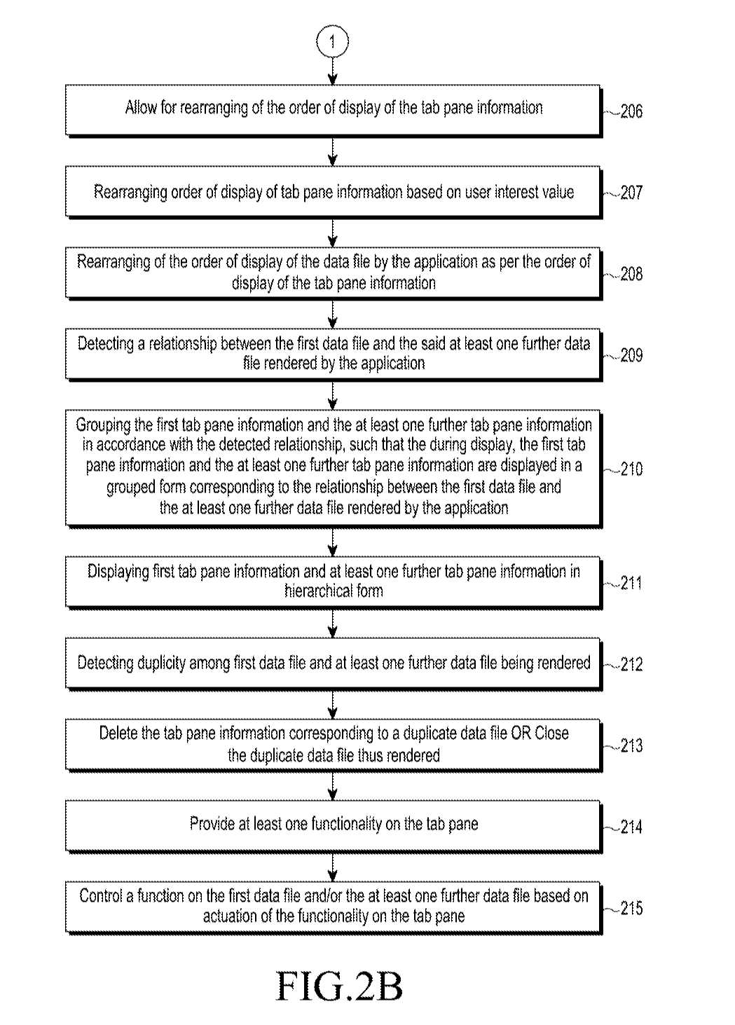

The method as illustrated in FIG. 1 can be supplemented with one or more additional operations as illustrated in FIGS. 2A and 2B. Particularly referring to operation 101 as previously described, it can be observed that the first tab pane information can correspond to either a first summary or to a first metadata of the first data file. Likewise, in operation 102, it can be observed that the at least one further tab pane information can correspond to either a further summary or to a further metadata of the at least one further data file.

FIGS. 2A and 2B illustrate a flowchart of a centralized navigation method according to various embodiments of the present disclosure.

Referring to FIG. 2A, depending upon one or more factors, the method for enabling a centralized navigation (200) comprises extracting first metadata from the first data file and extracting at least one further metadata from the at least one further data file at operation 201, or extracting from the first data file a first summary and extracting from the at least one further data file at least one further summary at operation 202.

By way of example, if the first metadata extracted from the first data file and at least one further metadata extracted from the at least one further data file satisfy at least one predetermined criterion at operation 203, then the same is used for extracting the first tab pane information and the at least one further tab pane information. On the other hand, if the first metadata extracted from the first data file and at least one further metadata extracted from the at least one further data file satisfy at least one predetermined criterion at operation 203, then a first summary is extracted from the first data file at operation 101 and at least one further summary is extracted from the at least one further data file and used for extracting the first tab pane information and the at least one further tab pane information at operation 102.

By way of a non-limiting example, the at least one predetermined criterion can be used to determine whether meaningful or sufficient information can be obtained from the metadata. If sufficient or meaningful information is available in the metadata, then the same is used for extracting the first tab pane information and the at least one further tab pane information. On the other hand, if the metadata does not contain sufficient information or alternatively, on the basis of information contained in the metadata, meaningful information is not extractable, then this criteria is said to be not satisfied, in which case the a first summary is extracted from the first data file and at least one further summary is extracted from the at least one further data file and the same are used for extracting the first tab pane information and the at least one further tab pane information. By way of non-limiting example, the meaningful information may be in the form of a group of words. In another non-limiting example, the meaningful information may be in the form of a sentence. In still another non-limiting example, the meaningful information may be in the form of a group of sentences, which may be arranged sequentially or in different portions. For more details about the process of extracting meaningful information, reference may be made to “summarization” as described in a later portion.

By way of yet another non-limiting example, the at least one predetermined criterion can be based on a device's processing capability. If the device's capabilities in terms of the speed or ability of processing is restricted, then the information as available in the metadata is used for extracting the first tab pane information and the at least one further tab pane information.

The method for enabling centralized navigation (200) can further comprise detecting an order of rendering of the first data file and the at least one further data file by the application at operation 204 and assigning the order thus detected to the extracted tab pane information at operation 205 such that during display, the first tab pane information and the at least one further tab pane information are displayed in an order corresponding to the order of rendering of the first data file and the at least one further data file rendered by the application at operation 103. This allows for the order of rendering of the first data file and the at least one further data file by the application and the order of rendering of the tab pane information to be consistent with each other.

Referring to FIG. 2B, the method for enabling centralized navigation (200) can further comprise allowing for rearranging of the order of display of the tab pane information at operation 206. The rearrangement can be done by a user manually. In an alternative, based on user behavior, the rearrangement of the order of display of the tab pane information can be done automatically at operation 207. For example, a user interest value corresponding to the first data file and the at least one further data file is calculated and based on the calculated user interest value, the order of display of the tab pane information can be re-arranged in a decreasing order or in an increasing order. The user interest value can be calculated for example, based on one or more factors which include time spent by the user viewing the data file, time spent by the user interacting with the data file, the number of times the user has viewed the data file, the number of times the user has interacted with the data file, the number of times the user has viewed or interacted with the data file in past sessions, the relevancy of the data file or the contents of the data file as to the user's actions, etc.

In case the order of display of the tab pane information, the order of display of the corresponding data file by the application is automatically re-arranged to maintain consistency with the order of display of the tab pane information at operation 208.

In many instances, there exists some relationship between the various data files which are being displayed by the application. Thus, the method for enabling centralized navigation (200) can further comprise detecting a relationship between the first data file and the at least one further data file rendered by the application at operation 209; and grouping, at operation 210, the first tab pane information and the at least one further tab pane information in accordance with the detected relationship, such that the during display, the first tab pane information and the at least one further tab pane information are displayed in a grouped form corresponding to the relationship between the first data file and the at least one further data file rendered by the application. In a preferred aspect of the disclosure, the grouping can be in a hierarchical form starting from a parent data file to one or more child data files to one or more grand-child data files and so on. Thus, once the first tab pane information and the at least one further tab pane information have been grouped, the same is displayed in a hierarchical form at operation 211.

It has been observed that sometimes the same data file has been opened in the application multiple times (in multiple tabs). In some instances, this may be due to error. Thus, the method for enabling centralized navigation (200) can further comprise detecting duplicity among the first data file and the at least one further data file being rendered by the application at operation 212. In response to detecting duplicity, the method (200) may operate so as to delete the tab pane information corresponding to a duplicate data file or close the duplicate data file thus rendered by the application at operation 213.

In addition to merely enabling for centralized tab navigation, the method can also enable for centralized tab functionality control. Thus, as illustrated in FIG. 2B, the method (200) can comprise providing at least one functionality on the tab pane at operation 214; and controlling a function on the first data file and/or the at least one further data file based on actuation of the functionality on the tab pane at operation 215.

In an aspect of the disclosure, the first summary or the at least one further summary is based on content contained in the corresponding data file or metadata of the corresponding data file and content contained in the corresponding data file.

Without limitation, a summary from a corresponding data file can be extracted using one or more of the following techniques: metadata and title of the data file; keyword based summarization method; sentence extraction based summarization method; extraction based summarization method; un-supervised key phrase extraction (text rank) based summarization method; and cohesive summary extraction.

In the following paragraph, a brief note about each of the above technique is provided by way of illustration.

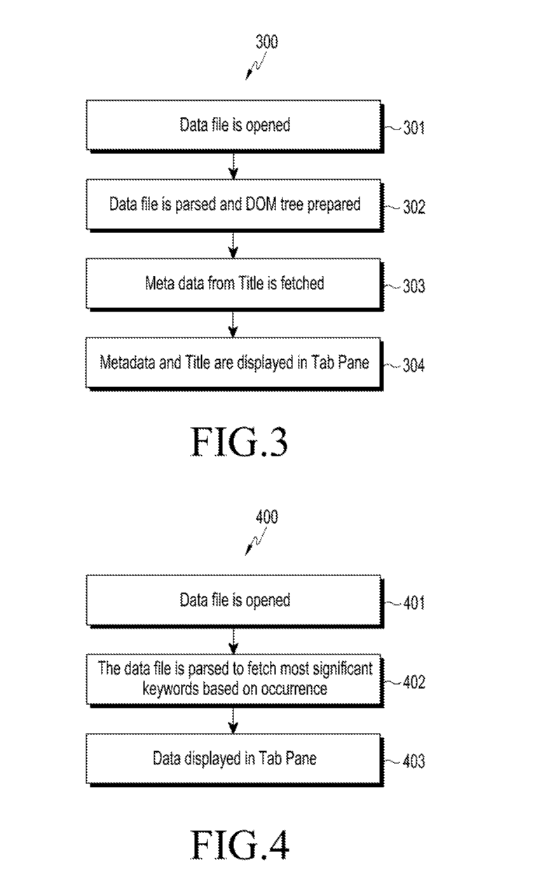

FIG. 3 illustrates a flowchart of a summarization method using meta data and title according to an embodiment of the present disclosure.

Referring to FIG. 3, a sample summarization method (300) using metadata and title of the data file is illustrated. The method (300) comprises opening the data file at operation 301, parsing the data file and preparing a document object model (DOM) tree structure at operation 302, fetching meta data and a title of the data file and summarizing the same at operation 303, and displaying the data on the tab pane at operation 304.

FIG. 4 illustrates a flowchart of a summarization method using keywords according to an embodiment of the present disclosure.

Referring to FIG. 4, a sample summarization method (400) using keyword is illustrated. The method (400) comprises opening the data file at operation 401, parsing the data file and fetching most significant keywords based on occurrence and summarizing the same at operation 402 and displaying the data on the tab pane at operation 403.

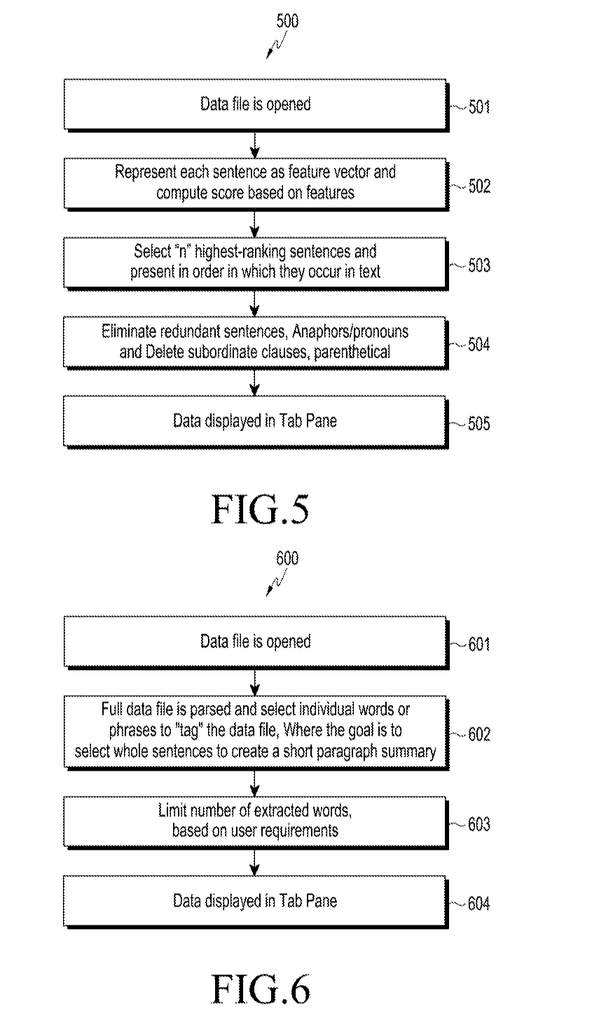

FIG. 5 illustrates a flowchart of a summarization method using sentence extraction according to an embodiment of the present disclosure.

Referring to FIG. 5, a sample summarization method (500) using sentence extraction is illustrated. The method (500) comprises opening the data file at operation 501, representing each sentence as a feature vector, and computing a score based on features at operation 502. The method (500) further comprises selecting “n” highest ranking sentences and presenting the same in order in which they occur in text at operation 503. In an optional embodiment, redundant sentences, anaphors or pronouns can be eliminated and likewise, subordinate clauses, parentheticals, etc. can be deleted at operation 504 while summarizing the sentence(s) and displaying the data on the tab pane at operation 505.

FIG. 6 illustrates a flowchart of a summarization method using extraction according to an embodiment of the present disclosure.

Referring to FIG. 6, a sample summarization method (600) using extraction is illustrated. The method (600) comprises opening the data file at operation 601, parsing the full data file, and selecting individual words or phrases to “tag” the data file, with a goal to select whole sentences to create a short paragraph summary at operation 602. In an optional embodiment, a number of extracted words can be limited based on a user requirement at the time of summarizing at operation 603 and the data is displayed on the tab pane at operation 604.

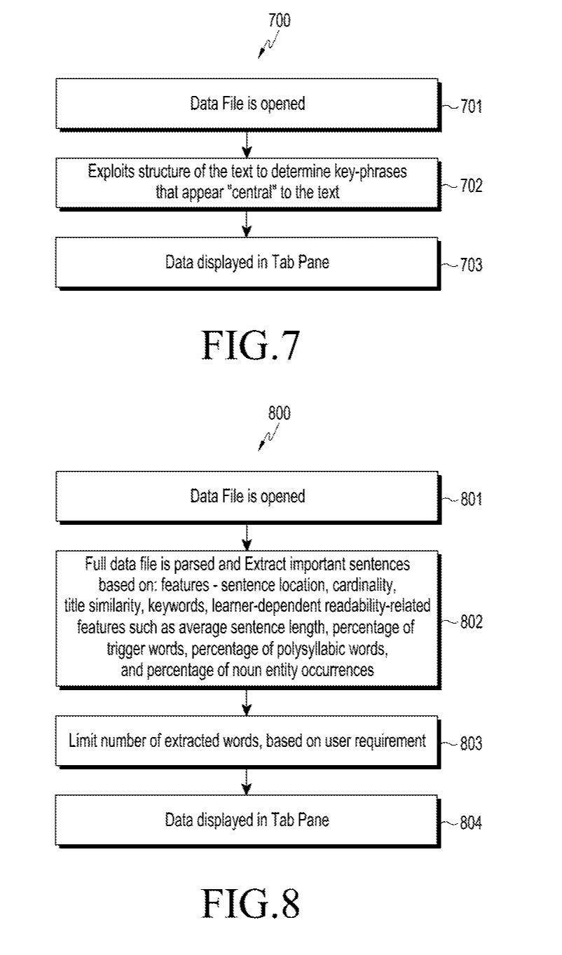

FIG. 7 illustrates a flowchart of a summarization method using unsupervised key phrase extraction according to an embodiment of the present disclosure.

Referring to FIG. 7, a sample summarization method (700) using un-supervised key phrase extraction (text rank) is illustrated. The method (700) comprises opening the data file at operation 701, analyzing a structure of the text to determine key phrases that appear central to the text and summarizing the same at operation 702, and displaying the data on the data pane at operation 703.

FIG. 8 illustrates a flowchart of a cohesive summary summarization method according to an embodiment of the present disclosure.

Referring to FIG. 8, a sample summarization method (800) using cohesive summary extraction is illustrated. The method (800) comprises opening the data file at operation 801. The full data file is parsed and important sentences are extracted at operation 802. Extraction of the important sentences can be based on one or more of: features—sentence location, cardinality, title similarity, keywords, learner-dependent readability-related features such as average sentence length, percentage of trigger words, percentage of polysyllabic words, and percentage of noun entity occurrences. In an optional embodiment, a number of extracted words can be limited based on a user requirement at the time of summarizing at operation 803 and the data is displayed on the tab pane at operation 804.

It may be noted that the summarization methods described above are merely examples of the summarization techniques as can be adopted by the present disclosure and that any other type of summarization can be adopted. Also, while adopting any of the above mentioned summarization techniques, one or more operations can be avoided or additional operations can be performed.

Now coming to the manner of representation of the tab pane, the tab pane can be represented in many different manners depending upon for example, a user's choice, device limitations, etc.

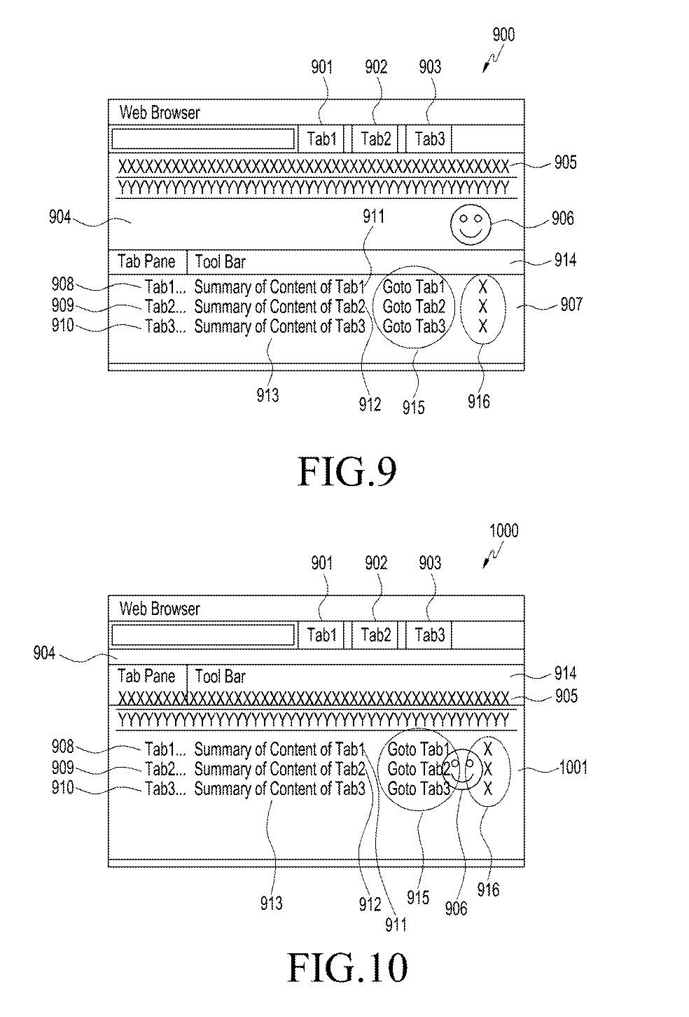

In an aspect of the present disclosure, the tab pane is displayed in the form of a sub-window, a new tab, an overlay, a pop-up, a side bar, etc. For the purposes of ease of understanding, the various views are illustrated in FIGS. 9 to 13 and described in detail in the following paragraphs.

FIG. 9 illustrates a screen shot of a browser interface rendering a sub-window tab pane according to an embodiment of the present disclosure.

Referring to FIG. 9, there is illustrated a web browser application (900). The web browser application is illustrated as providing a tabbed used interface for data file 1 in Tab1 (901), data file 2 in Tab2 (902) and data file 3 in Tab3 (903). Assuming Tab1 to be a selected tab (“active tab”), the contents of data file 1 are displayed to the user in the area (904) while other opened data files, associated with unselected tabs (“inactive tabs”), are hidden from the user's view. For the purposes of illustration, data file 1 is shown to comprise text (905) and an image (906). In accordance with an embodiment of the disclosure, a sub-window (907) is created and populated with a tab pane. The sub-window tab pane (907) is illustrated to comprise a name of Tab1 (908), a name of Tab2 (909) and a name of Tab3 (910). The sub-window tab pane (907) also comprises tab pane information corresponding to Tab1 (911), tab pane information corresponding to Tab2 (912) and tab pane information corresponding to Tab3 (913). The sub-window tab pane (907) is also illustrated to comprise of a tool bar (914), navigation functionality (915) and a close functionality (916). By operating the navigation functionality, the corresponding tab will be displayed to the user in the area (904). On the other hand, by operating the close functionality, the corresponding Tab will be closed.

FIG. 10 illustrates a screen shot of a browser interface rendering an overlay tab pane according to an embodiment of the present disclosure.

Referring to FIG. 10, there is illustrated a web browser application (1000). Similar to FIG. 9, the web browser application of FIG. 10 is illustrated as providing a tabbed used interface for data file 1 in Tab1 (901), data file 2 in Tab2 (902) and data file 3 in Tab3 (903). Assuming Tab1 to be a selected tab (“active tab”), the contents of data file 1 is displayed to the user in the area (904) while other opened data files, associated with unselected tabs (“inactive tabs”), are hidden from the user's view. For the purposes of illustration, data file 1 is shown to comprise text (905) and an image (906). In accordance with an embodiment of the disclosure, an overlay window (1001) is created and populated with a tab pane. The overlay tab pane window is illustrated as being partially transparent. The overlay tab pane window (1001) comprises elements as contained by the sub-window tab pane (907) of FIG. 9.

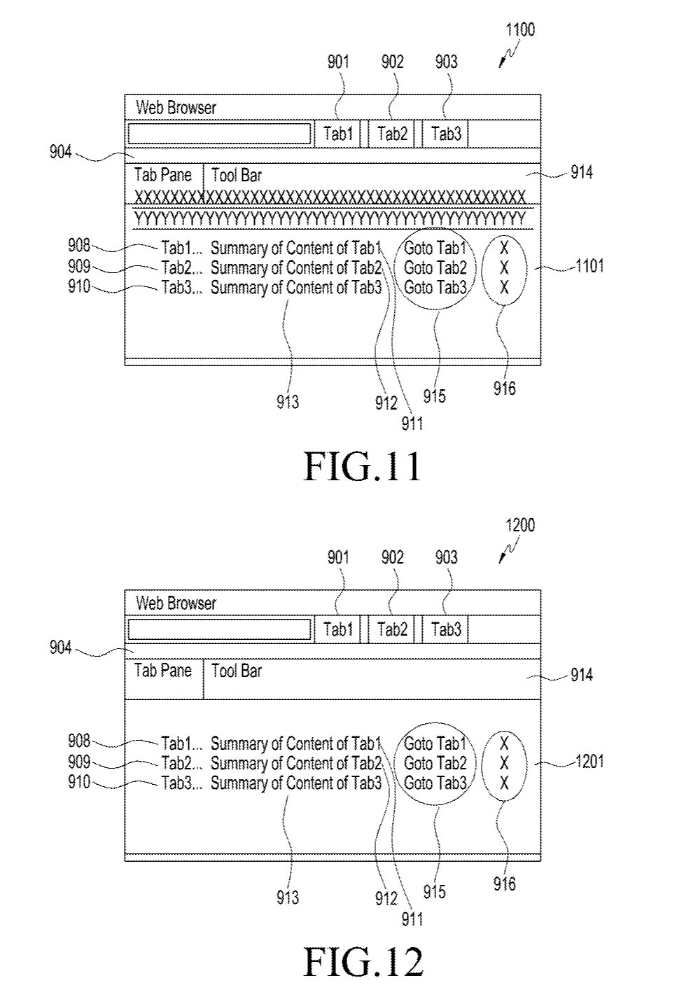

FIG. 11 illustrates a screen shot of a browser interface rendering a pop-up window tab pane according to an embodiment of the present disclosure.

Referring to FIG. 11, there is illustrated a web browser application (1100). Similar to FIG. 9, the web browser application of FIG. 11 is illustrated as providing a tabbed user interface for data file 1 in Tab1 (901), data file 2 in Tab2 (902) and data file 3 in Tab3 (903). Assuming Tab1 to be a selected tab (“active tab”), the contents of data file 1 are displayed to the user in the area (904) while other opened data files, associated with unselected tabs (“inactive tabs”), are hidden from the user's view. In accordance with an embodiment of the disclosure, a pop-up window (1101) is created and populated with a tab pane. The pop-up tab pane window (1101) is illustrated as occupying a part of area (904) while displaying opened data files. The pop-up window (1101) comprises elements as contained by the sub-window tab pane (907) of FIG. 9.

FIG. 12 illustrates a screen shot of a browser interface rendering a tab pane in a form of a fresh tab according to an embodiment of the present disclosure.

Referring to FIG. 12, there is illustrated a web browser application (1200). Similar to FIG. 9, the web browser application of FIG. 12 is illustrated as providing a tabbed used interface for data file 1 in Tab1 (901), data file 2 in Tab2 (902) and data file 3 in Tab3 (903). Assuming Tab1 to be a selected tab (“active tab”), the contents of data file 1 are displayed to the user in the area (904) while other opened data files, associated with unselected tabs (“inactive tabs”), are hidden from the user's view. In accordance with an embodiment of the disclosure, a new tab (1201) is created and populated with a tab pane. Once the new tab (1201) is selected, the contents of the same (which are similar to elements as contained by the sub-window tab pane (907) of FIG. 9) are depicted in the area (904).

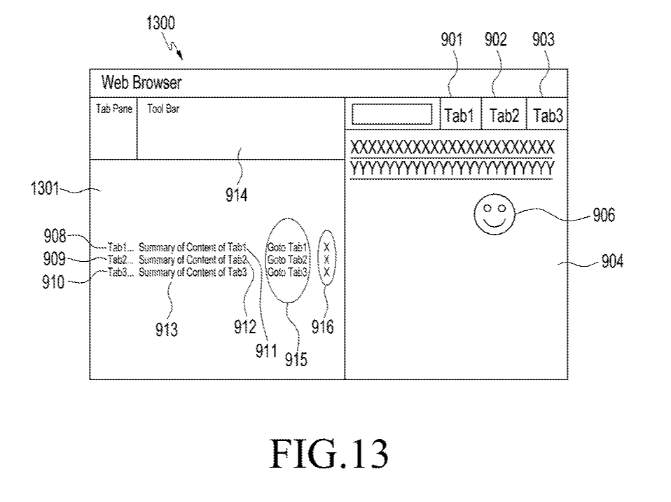

FIG. 13 illustrates a screen shot of a browser interface rendering a side-bar tab pane according to an embodiment of the present disclosure.

Referring to FIG. 13, there is illustrated a web browser application (1300). Similar to FIG. 9, the web browser application of FIG. 13 is illustrated as providing a tabbed user interface for data file 1 in Tab1 (901), data file 2 in Tab2 (902) and data file 3 in Tab3 (903). Assuming Tab1 to be a selected tab (“active tab”), the contents of data file 1 are displayed to the user in the area (904) while other opened data files, associated with unselected tabs (“inactive tabs”), are hidden from the user's view. In accordance with an embodiment of the disclosure, a side bar (1301) is created and populated with a tab pane. The side bar (1301) contents are similar to the elements as contained by the sub-window tab pane (907) of FIG. 9) alongside the area (904).

While in FIGS. 9 to 13, navigation from an active tab to an inactive tab is performed by operating the navigation functionality (915), providing such explicit navigation functionality (915) is merely an option.

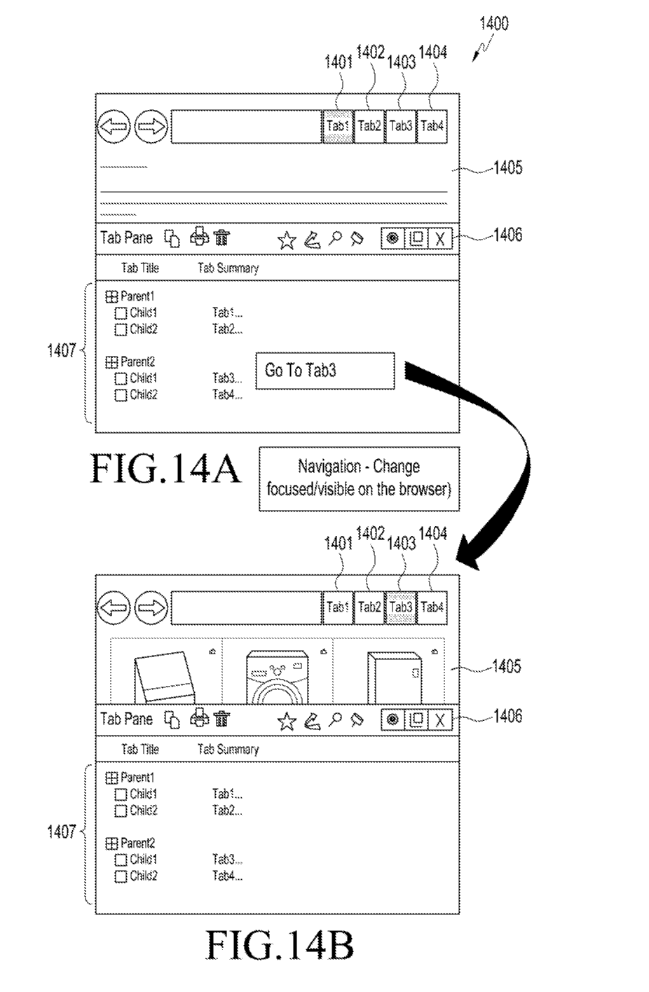

FIGS. 14A and 14B illustrate screen shots of navigation using a tab pane according to various embodiments of the present disclosure.

Referring to FIG. 14A in an alternative, there is illustrated a tabbed user interface (1400) as made available by an application in which the plurality of data files are being rendered in multiple tabs (1401, 1402, 1403 and 1404). The content of the data file corresponding to an active tab is rendered in a content rendering portion (1405). Assuming that Tab1 (1401) is the active tab, then the contents of data file 1 which are rendered in Tab1 are rendered in the content rendering portion (1405). A tab pane (1406) is provided which renders the tab pane information (1407) corresponding to all the data files that are currently opened in the tabs. The tab pane information corresponding to each tab is provide in the form of a hyperlink. Assuming that the user wishes to migrate to Tab3 (1403), he/she can simply click on the tab pane information corresponding Tab3 (which can be provided in the form of a hyperlink) and as illustrated in FIG. 14B, the content rendering portion (1405) will then render the content of data file 3 (i.e. the contents of Tab3), thus providing a user friendly centralized navigation method.

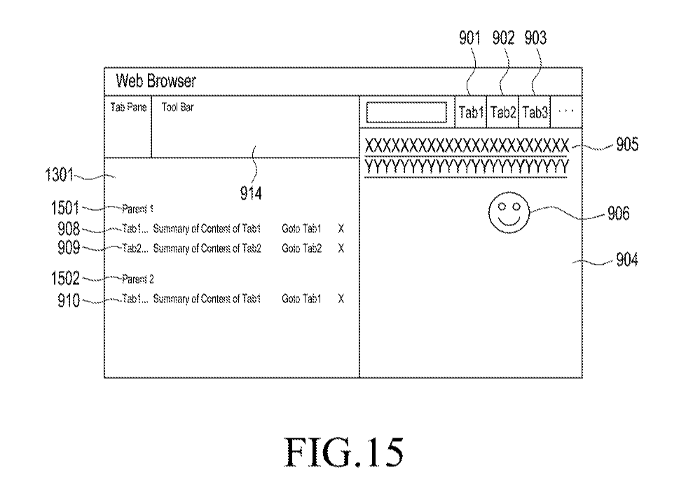

While in FIGS. 9 to 13, the tab pane information corresponding to each tab is shown in an independent form, as mentioned in FIGS. 2A and 2B, in case there exists some relationship between the various data files which are being displayed by the application, then it is possible to group the tab pane information in accordance with the detected relationship. This aspect of the grouping of tab pane information and displaying the grouped tab pane information in the tab pane is illustrated in FIG. 15.

FIG. 15 illustrates a screen shot of a browser interface rendering tab pane, with the tab pane comprising grouped tab pane information according to an embodiment of the present disclosure.

Referring to FIG. 15, assuming that data file 1 which is being rendered in Tab1 and data file 2 which is rendered in Tab2 are related to one another, the side bar (1301) comprises a first group named Parent 1 (1501) under which the tab pane information corresponding to Tab1 and tab pane information corresponding to Tab2 are grouped and a second group named Parent 2 (1502) under which the tab pane information corresponding to Tab3 is rendered.

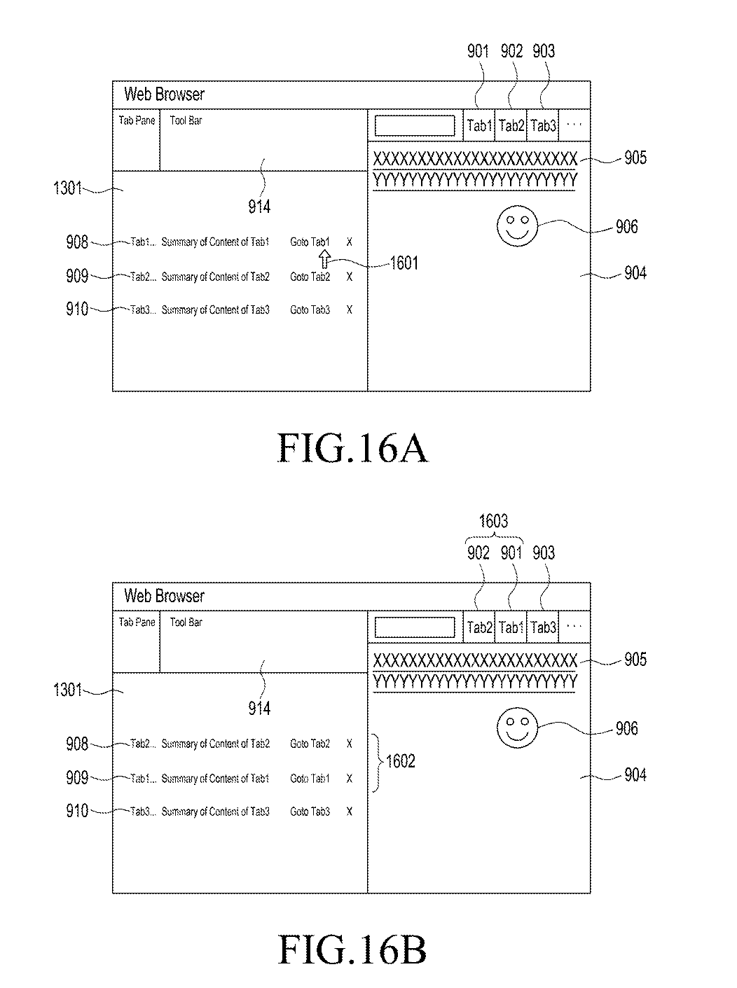

As mentioned in operation 206 of FIG. 2B, the method allows for re-arranging the order of display of the tab pane information. This aspect of the disclosure is illustrated in FIGS. 16A and 16B, wherein FIG. 16A illustrated an initial order of rendering of the tab pane information with the order being tab pane information pertaining to Tab1 (908) followed by tab pane information pertaining to Tab2 (909) further followed by tab pane information pertaining to Tab3 (910).

FIGS. 16A and 16B illustrate screen shots of re-arranging tab pane information within a tab pane and a resultant re-arranging of tabs within a multi-tabbed browser interface according to various embodiments of the present disclosure.

Referring to FIGS. 16A and 16B, assuming that the user does the re-arranging action (1601) of tab pane information pertaining to Tab1 (908) and tab pane information pertaining to Tab2 (909), an outcome of the action (1602) is illustrated in FIG. 16B, wherein it can be now noticed at that tab pane information pertaining to Tab2 (909) is depicted above followed by tab pane information pertaining to Tab1 (908). FIG. 16B further illustrates rearranging (1603) an order of display of the corresponding data file in the tabs (901 and 902) by the application to maintain consistency with the order of display of the tab pane information.

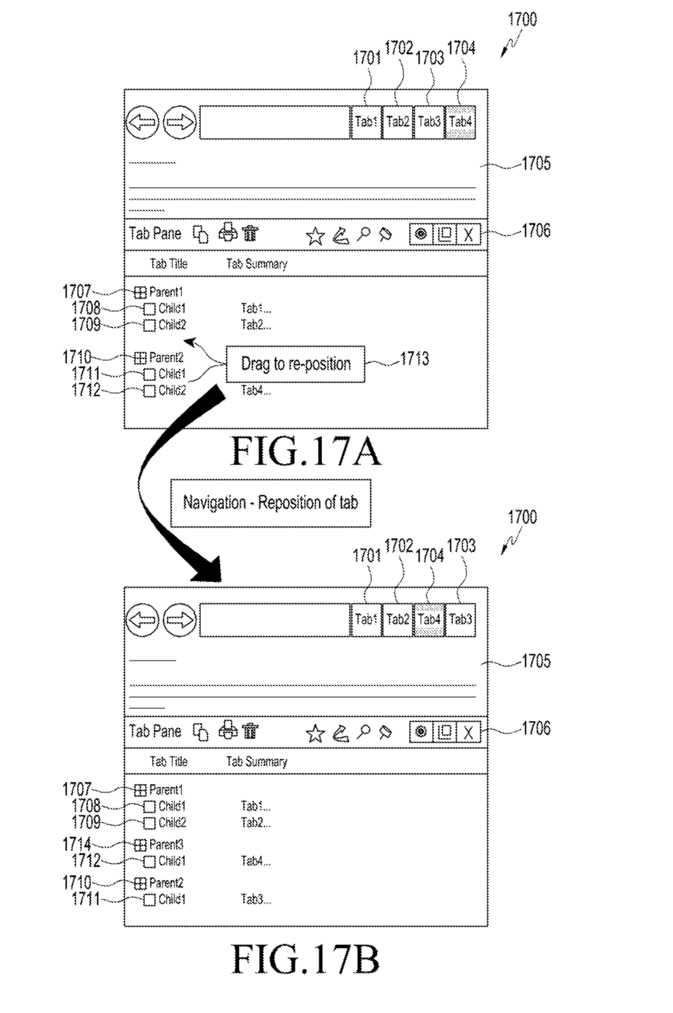

The re-arranging option can be performed within a group so as to re-arrange an order of display of the tab pane information within a group. Also, the re-arranging option can be performed for the purposes of re-grouping existing groups. This aspect of the disclosure is illustrated in FIGS. 17A and 17B, wherein FIG. 17A illustrates a tabbed user interface (1700) as made available by an application in which the plurality of data files are being rendered in multiple tabs (1701, 1702, 1703 and 1704).

FIGS. 17A and 17B illustrate screen shots of a re-arranging of tab pane information within a tab pane and a resultant re-arranging of tabs within a multi-tabbed browser interface according to various embodiments of the present disclosure.

Referring to FIGS. 17A and 17B, the content of a data file corresponding to an active tab is rendered in a content rendering portion (1705) and a tab pane (1706) is provided which renders the tab pane information corresponding to all the data files that are currently opened in the tabs.

Assuming that by following operation 209 as illustrated in FIG. 2B, it was initially detected that the data file 1 which is being rendered in Tab1 (1701) and data file 2 which is rendered in Tab2 (1702) are related to one another, while the data file 3 which is being rendered in Tab3 (1703) and data file 4 which is rendered in Tab4 (1704) are related to one another. Accordingly, a first group named Parent 1 (1707) under which the tab pane information corresponding to Tab1 (1708) and tab pane information corresponding to Tab2 (1709) are grouped and a second group named Parent 2 (1710) under which the tab pane information corresponding to Tab3 (1711) and the tab pane information corresponding to Tab4 (1712) are grouped and the grouping is rendered. In case the user wishes to re-group, for example, if the user wishes to represent the data file 4 which is rendered in Tab4 as a separate group, then he/she can perform a regrouping action (1713) on the tab pane information corresponding to Tab4 (1712).

In response to the regrouping action (1713), as illustrated in FIG. 17B, a fresh (third) group is created which is named as Parent 3 (1714) to include tab pane information corresponding to Tab4 (1712) and the second group named Parent 2 (1710) is re-grouped so as to include tab pane information corresponding to Tab3 (1711). In an optional embodiment, the order of tabs as rendered by the application is re-arranged so as to be consistent with the order of rendering of the tab pane information in the tab pane. In the illustrated embodiment, the order of rendering of the tabs by the application is re-arranged to Tab1 (1701), Tab2 (1702), Tab4 (1704) and Tab3 (1703).

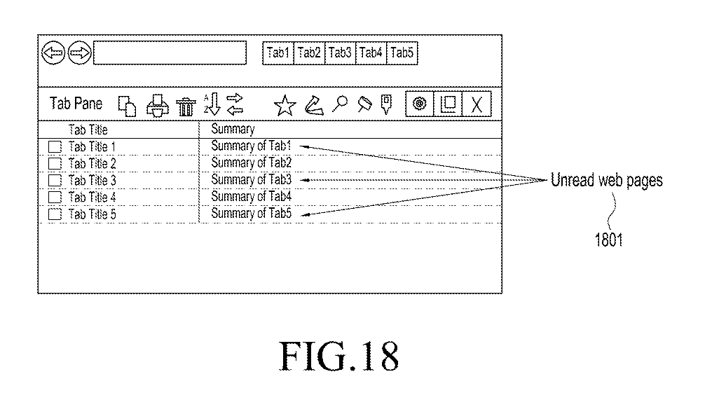

In an aspect of the disclosure, the tab pane information pertaining to a particular data file is displayed so as to be visually differentiated from remaining tab pane information based on a predetermined criterion. This aspect of the disclosure is illustrated in FIG. 18, wherein a tabbed user interface as made available by an application is rendering plurality of data files in multiple tabs.

FIG. 18 illustrates a screen shot showing tab pane information pertaining to different data files being displayed in a visually differentiated manner according to an embodiment of the present disclosure.

Referring to FIG. 18, assuming that the data file 1 as rendered in Tab1, data file 3 as rendered in Tab3 and data file 5 as rendered in Tab5 have not been viewed, then the tab pane information corresponding to Tab1, Tab3 and Tab5 (collectively shown as 1801) as rendered on the tab pane so as to be visually differentiated from the tab pane information corresponding to Tab2 and Tab4. This approach can be adopted to differentiate for example, a last opened tab from the remaining tabs or an active tab from the inactive tabs, etc.

To cater to ease of navigation, as mentioned in FIG. 2B, duplicity in the data file being rendered by the application is detected (operations 212) and appropriate action (operation 213) can be taken.

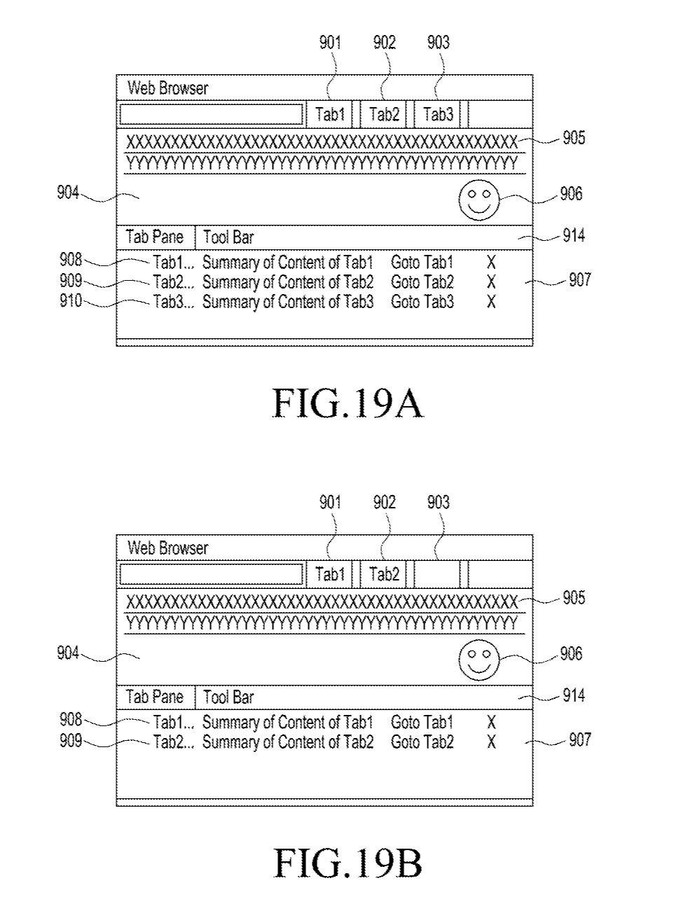

FIGS. 19A and 19B illustrate screen shots showing removal of duplicate tab pane information and closing of the duplicate tab according to various embodiments of the present disclosure.

Referring to FIGS. 19A and 19B, this aspect of the disclosure is illustrated. Assuming that in FIG. 19A data file 1 as opened in Tab1 (901) is the same as data file 3 as opened in Tab3 (903), then it can be observed that there exists duplicity. Thus, in accordance with operation 213 of FIG. 2B, the tab pane information corresponding to Tab3 (910) is deleted as illustrated in FIG. 19B. In the illustrated example, the tab depicting data file 3 (903) is also illustrated as being closed.

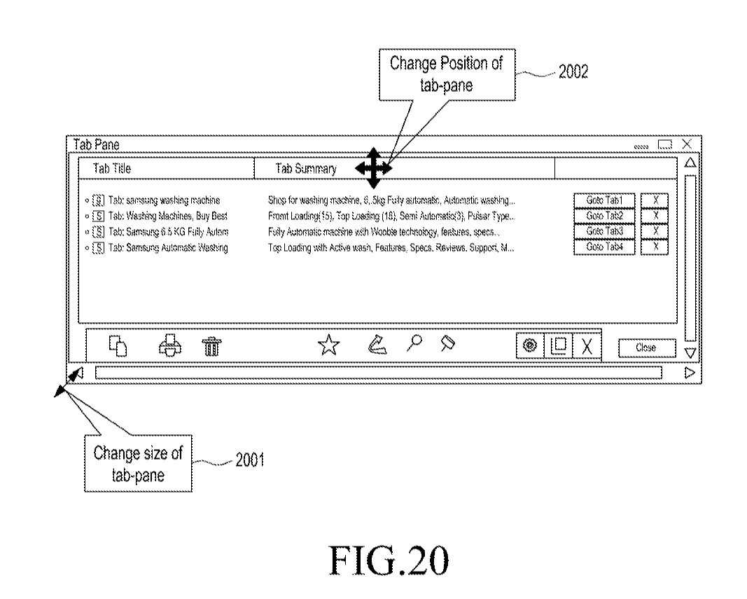

FIG. 20 illustrates a shot showing re-sizing and re-location of a tab pane according to an embodiment of the present disclosure.

Referring to FIG. 20, the size of the tab pane can be changed (2001) and/or the location of the tab pane can be changed (2002).

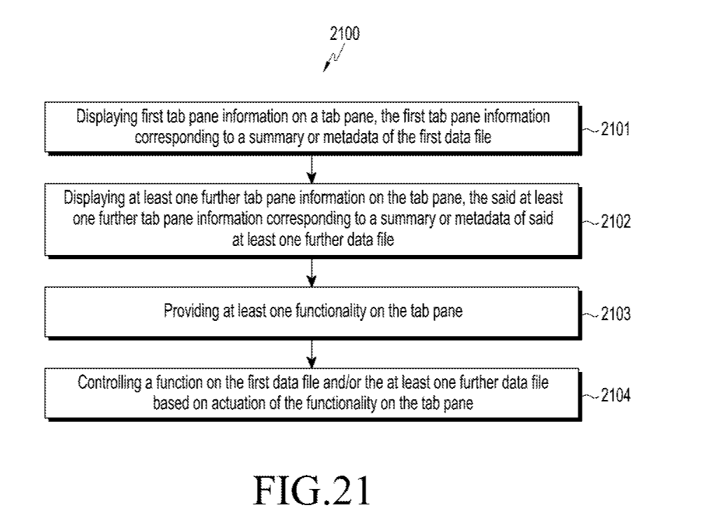

FIG. 21 illustrates a flowchart of a centralized control method according to an embodiment of the present disclosure.

Referring to FIG. 21, in considering centralized tab functionality control, there is provided a method (2100) that comprises: displaying first tab pane information on a tab pane, the first tab pane information corresponding to a summary or metadata of the first data file at operation 2101; displaying at least one further tab pane information on the tab pane, the at least one further tab pane information corresponding to a summary or metadata of the at least one further data file at operation 2102; providing at least one functionality on the tab pane at operation 2103; and controlling a function on the first data file and/or the at least one further data file based on actuation of the functionality on the tab pane at operation 2104.

The nature of functionality that can be provided and therefore controlled is selected from a group comprising of a navigation functionality, an opening functionality, a closing functionality, a refreshing functionality, a bookmarking functionality, a pinning functionality, a printing functionality, finding of a keyword functionality, searching for a keyword functionality, a copy functionality, a paste functionality, a dragging functionality, a docking functionality, a minimizing functionality, a maximizing functionality, a restoring functionality, a scrolling functionality, an expanding functionality, a webpage control functionality, a document editing functionality and a collapsing functionality.

In an embodiment of the present disclosure, controlling comprises controlling in a batch mode a function on the first data file and the at least one further data file based on actuation of the functionality on the tab pane.

In an embodiment of the present disclosure, controlling comprises controlling a function on the first data file and/or the at least one further data file based on a sequential actuation of a plurality of functionalities on the tab pane.

In an embodiment of the present disclosure, controlling comprises controlling a plurality of functions on the first data file and/or the at least one further data file based on actuation of one or more functionalities on the tab pane.

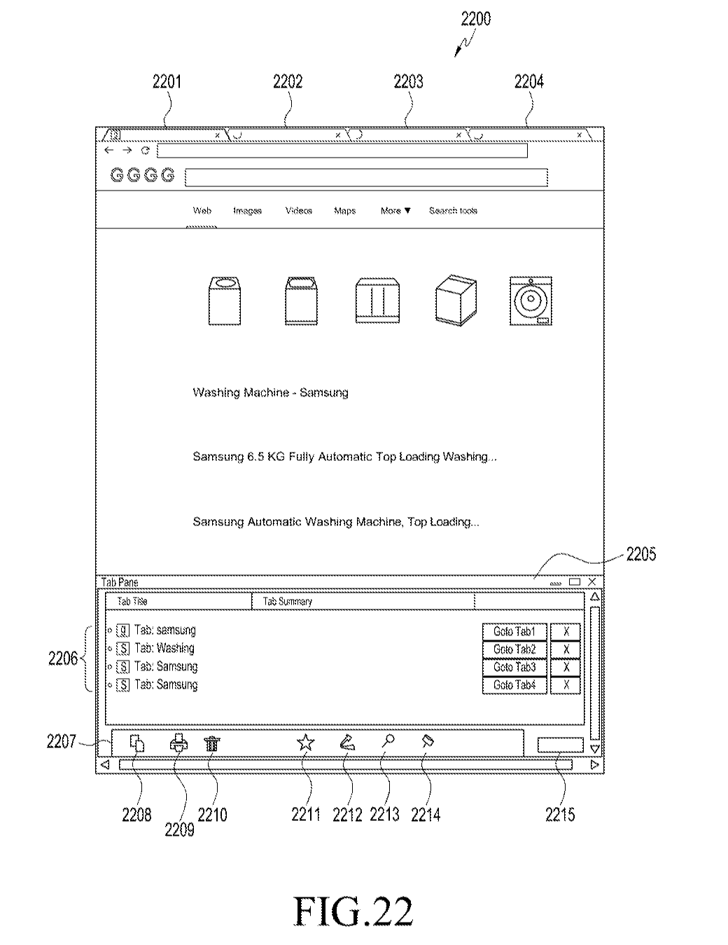

FIG. 22 illustrates a screen shot of a browser interface rendering a tab pane with functionality control options according to an embodiment of the present disclosure.

Referring to FIG. 22, there is illustrated a web browser (2200) depicting plurality of tabs (2201, 2202, 2203 and 2204). There is also illustrated a tab pane in the form of a sub-window (2205). The tab pane (2205) is providing the tab pane information (2206). At the bottom of the tab pane (2205) is provided a tool bar (2207). The tool bar comprises one or more functionalities that are linked to the tabs. One or more of the tab pane information can be selected by the user and functionality as provided in the tool bar can be actuated. In response to actuation of the functionality on the tool bar, the corresponding functionality on the tab(s) corresponding to the selected tab pane information is actuated and performed. For example, the tool bar is illustrated as comprising a copy uniform resource locator (URL) function (2208). Upon selection of a tab pane information and actuation of the copy URL function (2208), the URL corresponding to the particular tab will be copied. On the other hand, if no tab pane information is selected, URLs of all opened tabs can be copied. Likewise, the tool bar is illustrated as comprising a print function (2209). Upon selection of a tab pane information and actuation of the print function (2209), the contents as being rendered by the particular tab will be printed. On the other hand, if no tab pane information is selected, contents rendered by all opened tabs can be printed. The tool bar is further illustrated as comprising a close tab function (2210). Upon selection of a tab pane information and actuation of the close tab function (2210), the corresponding tab will be closed. On the other hand, if no tab pane information is selected, all opened tabs can be closed.

The tool bar is furthermore illustrated as comprising an Add to Bookmark function (2211). Upon selection of a tab pane information and actuation of the Add to Bookmark function (2211), the URL corresponding will be saved as a bookmark. On the other hand, if no tab pane information is selected, URL corresponding to all opened tabs will be saved as bookmarks. The tool bar is further illustrated as comprising a refresh function (2212). Upon selection of a tab pane information and actuation of the refresh function (2212), the contents of the corresponding tab will be refreshed. In an advantages option, without selecting any tab pane information, the refresh function can be actuated which can result in refreshing the contents of all opened tabs. The tool bar is furthermore illustrated as comprising a search/find function (2213). Upon selection of tab pane information, providing a key word and actuation of the search/find function (2213), the content will be searched through the corresponding tab. In an advantageous option, without selecting any tab pane information a key word can be provided and the search/find function (2213) can be actuated. This can result in searching for the keyword in all of the opened tabs. If the key word is found in some of the opened tabs, the tab pane information corresponding to such tabs can be visually distinguished from the remaining tabs. The tool bar is further illustrated as comprising a pin out function (2214). Upon selection of a tab pane information and actuation of the pin out tab function (2214), the corresponding tab will be pinned to a designated located. On the other hand, if no tab pane information is selected, all opened tabs can be pinned-out. Also, there can be a close function (2215) which when operated can close the tool bar (2207) in the tab pane (2205).

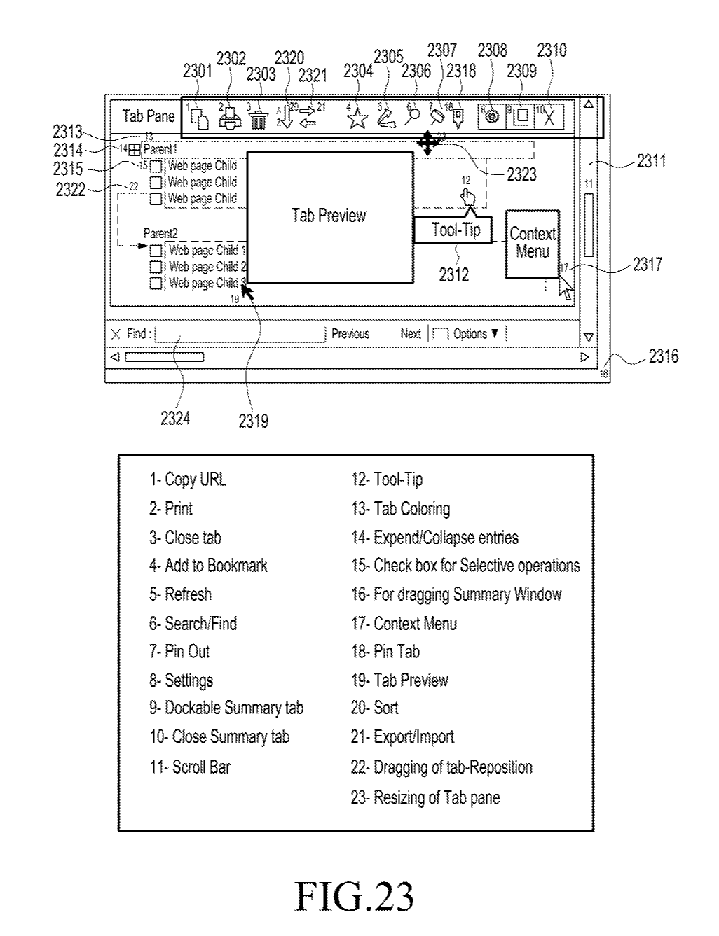

Apart from the above described functions, many other common control functionalities can be provided in the tab pane and some of the additional one are described and illustrated with reference to FIG. 23.

FIG. 23 illustrates a screen shot of a browser interface rendering a tab pane with centralized functionality control options according to an embodiment of the present disclosure.

Referring to FIG. 23, the tab pane is illustrated to include the following functionalities:
Copy URL (2301); Tab Coloring (2313);
Print (2302); Expand/Collapse Tab (2314);
Close Tab (2303); Check box for selective operation Add to bookmark (2304); (2315);
Refresh (2305); For dragging Summary window Search/Find (2306); (2316);
Pin Out (2307); Context menu (2317);
Settings (2308); Pin tab (2318);
Dockable Summary Tab Tab Review (2319); (2309); Sort (2320);
Close Summary Tab (2310); Export/Import (2321);
Scroll Bar (2311); Dragging of tab—reposition Tool tip (2312); (2322);
   Resizing of tab pane (2323); and
   Receiving search key word (2324)

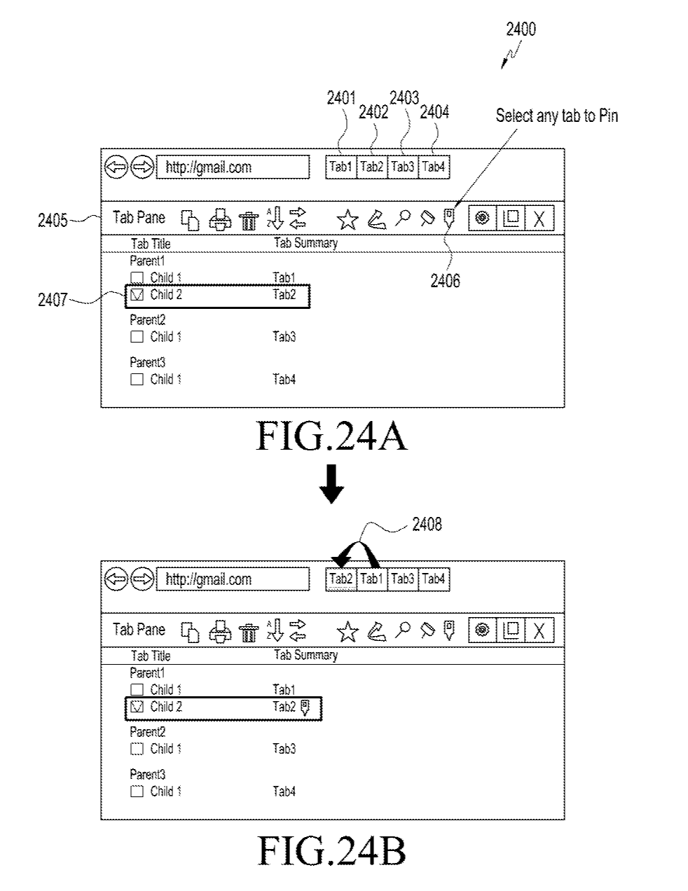

In the following paragraphs, the operations of providing at least one functionality on the tab pane and controlling a function on the data file based on actuation of the functionality on the tab pane is illustrated and explained with the help of FIGS. 24A, 24B, 25, 26A, 26B, 27A, 27B, 28A, 28B, 28C, 28D, 28E, 29A, 29B, 30, 31, 32A, and 32B.

FIGS. 24A and 24B illustrate screen shots showing actuation of a pin-function on a tab pane and its effect according to various embodiments of the present disclosure.

Referring to FIG. 24A, there is illustrated a web browser (2400) depicting plurality of tabs (2401, 2402, 2403 and 2404). There is also illustrated a tab pane in the form of a sub-window (2405). The tab pane (2405) is providing a pin function (2406) and tab pane information (2407). The user can select tab pane information pertaining to any of the tabs and activate the pin function.

Referring to FIG. 24B, in response to detecting actuation of the pin function, the corresponding tab is pinned to the start (2408).

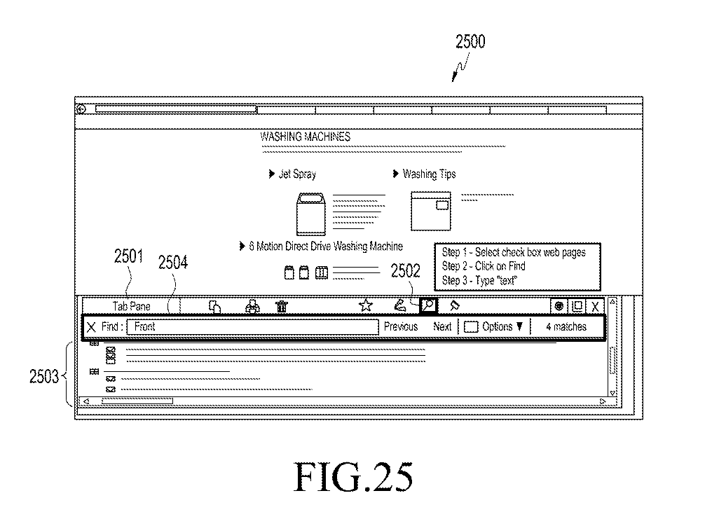

FIG. 25 illustrates a screen shot showing performance of a search function using a centralized functionality control option as provided on a tab pane according to an embodiment of the present disclosure.

Referring to FIG. 25, there is illustrated a web browser (2500) depicting plurality of tabs. There is also illustrated a tab pane in the form of a sub-window (2501). The tab pane (2501) is providing a search function (2502) and tab pane information (2503). The user can select tab pane information pertaining to any of the tabs and activate the search function (2502) and provide the key word for searching in the search window (2504). Alternatively, without selecting any tab pane information, the user can merely search function (2502) and provide the key word for searching in the search window (2504).

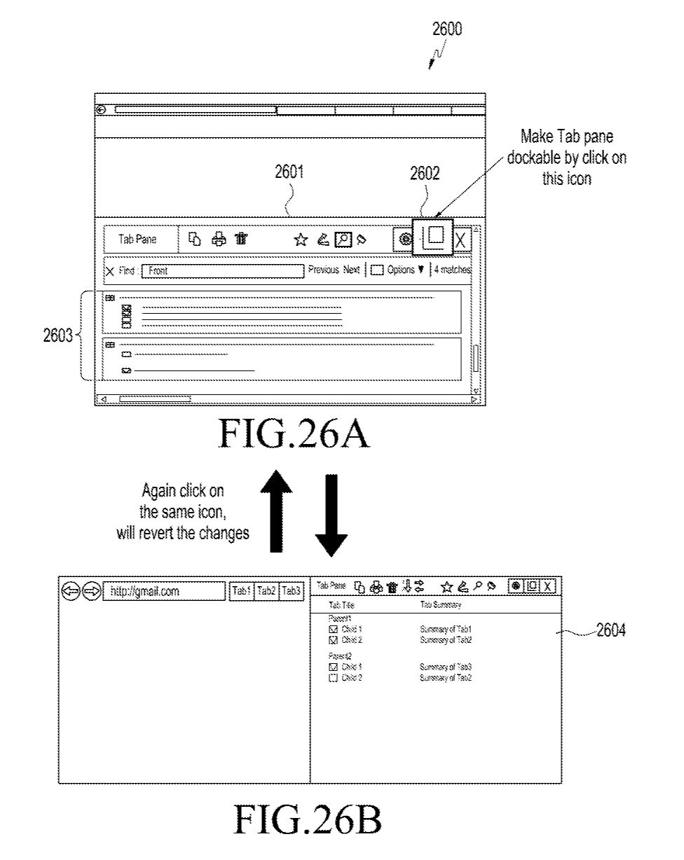

FIGS. 26A and 26B illustrate screen shots showing performance of a dockable summary tab function using a centralized functionality control option as provided on a tab pane and its effect according to various embodiments of the present disclosure.

Referring to FIG. 26A, there is illustrated a web browser (2600) depicting plurality of tabs. There is also illustrated a tab pane in the form of a sub-window (2601). The tab pane (2601) is providing a dockable summary tab function (2602) and tab pane information (2603).

Referring to FIG. 26B, in response to actuating the dockable summary tab function (2602) the tab pane is docked (2604).

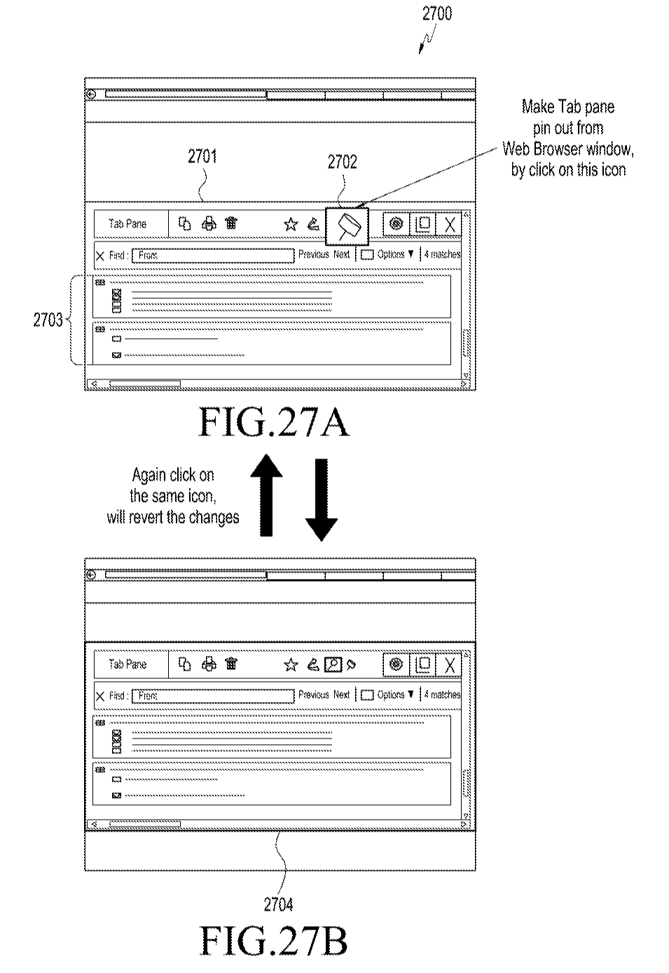

FIGS. 27A and 27B illustrate screen shots showing performance of a pin-out function using a centralized functionality control option as provided on a tab pane and its effect according to various embodiments of the present disclosure.

Referring to FIG. 27A, there is illustrated a web browser (2700) depicting plurality of tabs. There is also illustrated a tab pane in the form of a sub-window (2701). The tab pane (2701) is providing a pin-out tab function (2702) and tab pane information (2703).

Referring to FIG. 27B, in response to actuating the pin-out tab function (2702) the location of the tab pane is now changeable (2704).

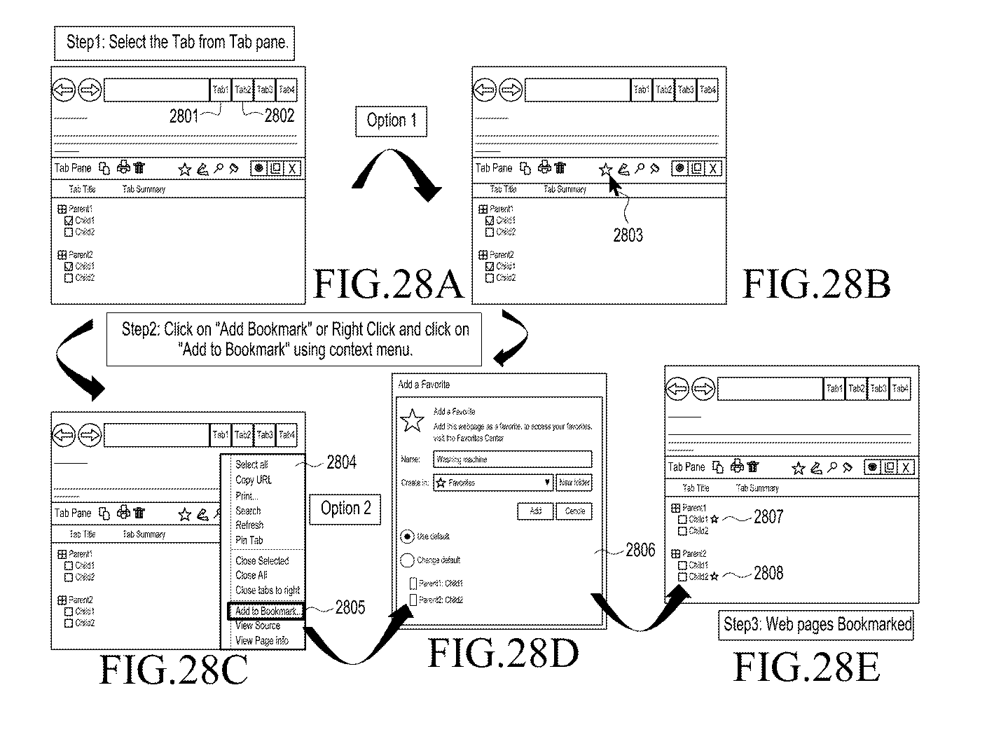

FIGS. 28A, 28B, 28C, 28D and 28E illustrate screen shots showing performance of an add to bookmark function using a centralized functionality control option as provided on a tab pane and its effect according to various embodiments of the present disclosure.

Referring to FIGS. 28A to 28E, there is illustrated a process for bookmarking a tab via the common control functionality as provided on the tab pane. Particularly, as illustrated by FIG. 28A, a selection is made of one or more tab pane information (2801 and 2802). Then in a first option, as illustrated in FIG. 28B, a selection is made of the bookmark function (2803) as provided in the tool bar. In an alternative embodiment as illustrated in FIG. 28C, from a context menu (2804), the book mark option (2805) is selected. By way of example, the context menu can be invoked by a right click of a mouse. As illustrated in FIG. 28D, a confirmation may be sought from the user (2806) for adding the selected tabs to the bookmark. Upon receiving a confirmation, the selected tabs are added to the bookmark and an indication may be provided (2807, 2808) on the tab pane. It may be noted that in the same way as described above functions such as refreshing content, printing, pinning the tabs, closing the tabs, copy URL, search keyword, view page source and view page information can be performed. Of these, view page source, view page information can be advantageously provided via the context menu option.

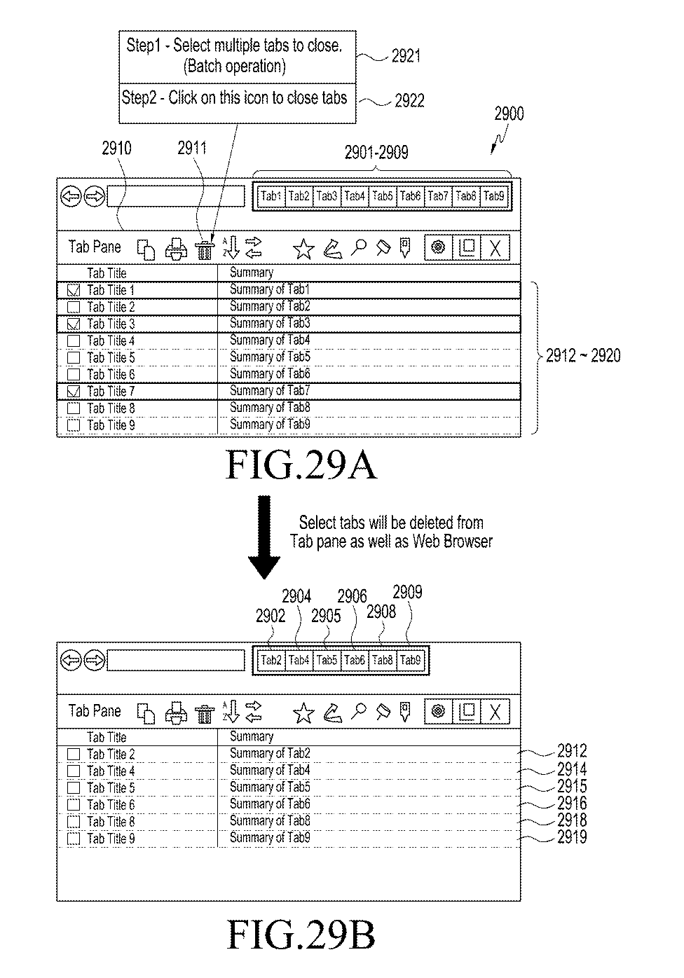

FIGS. 29A and 29B illustrate screen shots showing performance of a batch-wise tab close function using a centralized functionality control option as provided on a tab pane and its effect according to various embodiments of the present disclosure.

Referring to FIGS. 29A and 29B, there is illustrated a process for closing tabs via the common control functionality as provided on the tab pane. Particularly, a web browser (2900) depicting a plurality of tabs (2901-2909) is illustrated. There is also illustrated a tab pane in the form of a sub-window (2910). The tab pane (2910) is providing a delete function (2911) and tab pane information (2912-2920). As further illustrated in FIG. 29A, a selection is made (2921) of one or more tab pane information (2912, 2914 and 2918). Then the delete function is actuated (2922). As illustrated in FIG. 29B, in response to the aforesaid action, the selected tab pane information and their corresponding tabs are deleted. Thus, in FIG. 29B, it can be observed that the tab pane information presented in the tab pane are re-rendered with only non-deleted tab information (2902, 2904, 2905, 2906, 2908, and 2909) being present and likewise only the tabs corresponding to the non-deleted tab information (2912, 2914, 2915, 2916, 2918 and 2919) being rendered by the application.

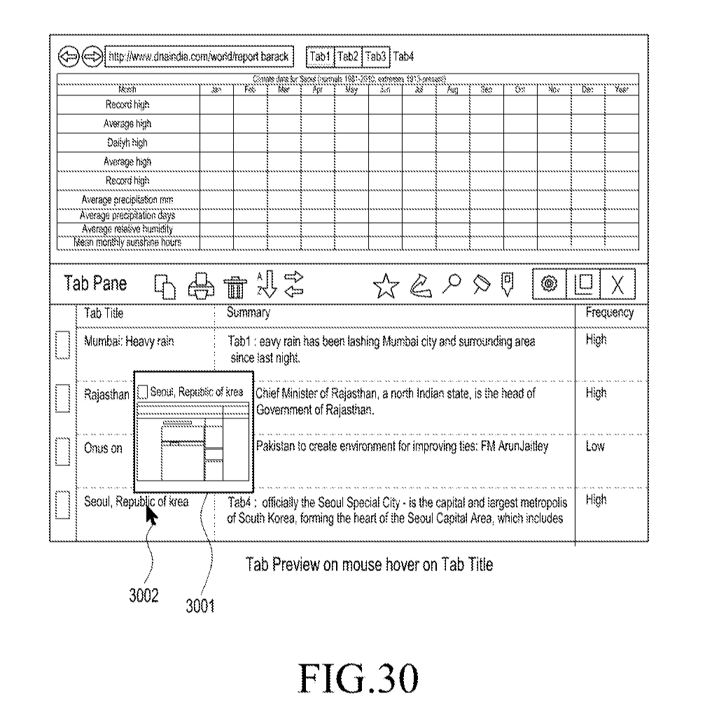

FIG. 30 illustrates providing preview functionality on a common control tab pane according to an embodiment of the present disclosure.

Referring to FIG. 30, there is illustrated providing preview functionality on the common control tab pane. The preview (3001) of the contents of a tab can be provided upon detecting a hovering (3002) of cursor on the tab pane information. Providing such preview functionality can assist the user in terms of navigation as well actuation of functionality on the common control tab pane.

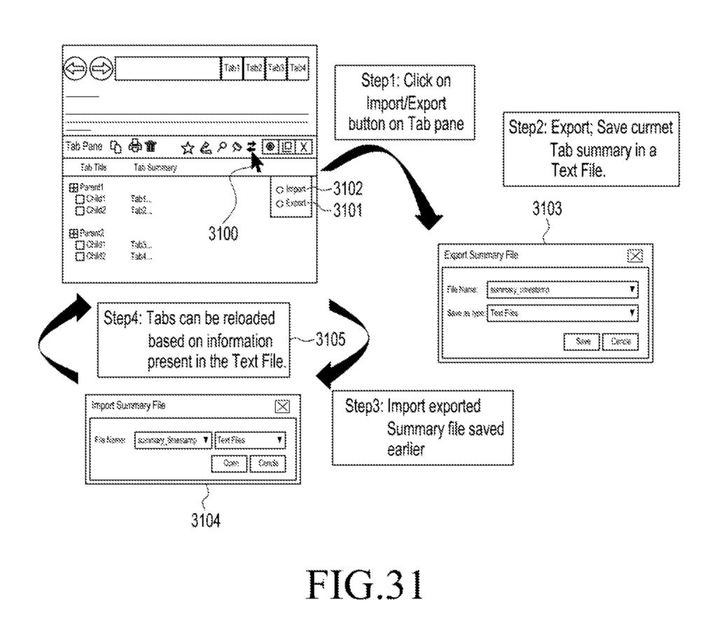

FIG. 31 illustrates screen shots showing performance of an import/export function using a centralized functionality control option as provided on a tab pane and its effect according to an embodiment of the present disclosure.

Referring to FIG. 31, there is illustrated the process in relation to providing export/import functionality. In response to selecting (3100) the import/export functionality as provided in the tool bar of the tab pane, the user may be presented with the option to select an export function (3101) or an import function (3102). In case the user selects the export function (3101), then the contents of the data file as rendered by the tab will be exported and stored (3103) (in accordance with the nomenclature as provided by the user). On the other hand, in case the user selects the import function (3102), then a graphical user interface (3104) may be presented which allows for the user to select a previously exported data file. Upon selection of a previously exported data file, a tab will be loaded (or reloaded) based on the information contained in the previously exported file (3105).

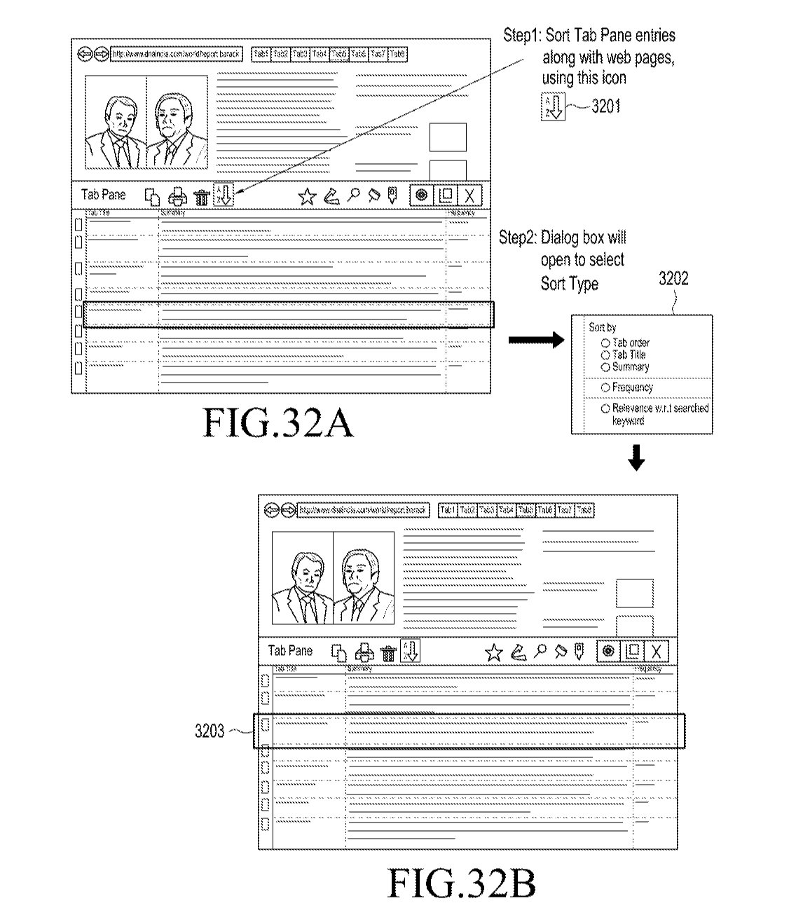

FIGS. 32A and 32B illustrate screen shots showing performance of a sorting function using a centralized functionality control option as provided on a tab pane and its effect according to various embodiments of the present disclosure.

Referring to FIGS. 32A and 32B, it is possible to sort the tabs using the sort function as provided in the tool bar of the tab pane. Thus, in FIG. 32A, an initial order of rendering of the tabs in the application along with the order of rendering of the tab pane information in the tab pane is illustrated. Now a user can select the sort function (3201) from the tool bar of the tab pane. The user may then be presented with one or more options (3202) for sorting the tabs including for example, sorting by tab summary, sorting by tab title, sorting by tab order, sorting based on frequency of visits or sorting based on relevance with respect to searched keyword.

By way of example, the tabs can be sorted based on the frequency of visits. It can be noticed that the tab pane is able to track a frequency of visits to the tabs and based on the same, the tab pane presents along with the tab pane information data relating to frequency of visit. Thus, in case the user selects to sort the tabs pane information based on the frequency of visits, as illustrated in FIG. 32B, the tab pane information will be re-arranged as per the frequency of visit and also the order of rendering of the tabs will be rearranged (3203).

On the other hand, if the user has provided a search keyword and wishes to sort the tab pane information and the tabs with respect to relevance to the search key word, the user can select the option of sorting based on relevance with respect to the searched keyword. In such a case, based on the relevance of the data file to the search key word, the tab pane information and tabs will be re-arranged.

While in the above paragraphs the method and examples illustrating the same have been described, the following paragraphs describe a system that can implement the method.

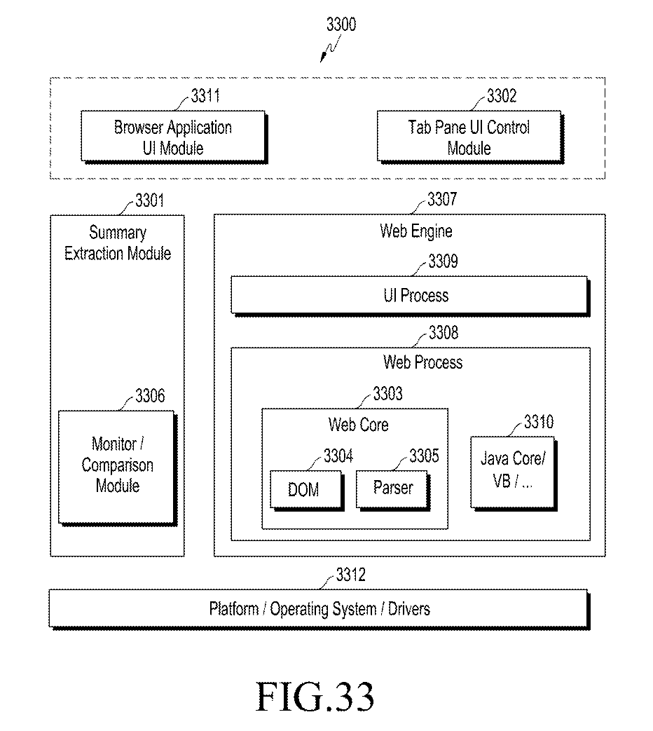

FIG. 33 illustrates a block diagram of a system performing a centralized navigation method and a centralized control method according to an embodiment of the present disclosure.

Referring to FIG. 33, there is provided a system (3300) comprising a summary extraction module (3301) for extracting first tab pane information from a first data file, the first tab pane information corresponding to a summary or metadata of the first data file. The summary extraction module (3301) is further adapted to extracting at least one further tab pane information from at least one further data file, the at least one further tab pane information corresponding to a summary or metadata of the at least one further data file. The system (3300) further comprises a tab pane user interface control module (3302) for displaying in a tab pane, the first tab pane information and the at least one further tab pane information.

The system further comprises a web core (3303) in operable inter-relationship with the summary extraction module (3301), wherein the web core (3303) may in turn further comprise a DOM determining module (3304) and/or a parser module (3305) for extracting tab pane information from a corresponding file. The summary extraction module (3301) may in turn comprise a monitor or a comparator module (3306) for determining satisfaction of the first metadata or the at least one further metadata with at least one pre-determined criterion.

The system (3300) further comprises a web engine module (3307) for detecting an order of rendering of the first data file and the at least one further data file by the application. The web engine module (3307) assigns the order thus detected to the extracted tab pane information such that the during display by the tab pane user interface control module (3302), the first tab pane information and the at least one further tab pane information are displayed in an order corresponding to the order of rendering of the first data file and the at least one further data file rendered by the application.

Apart from the above, the web engine module (3307) performs other functions including background functions. By way of a non-limiting example, the web engine module (3307) is adapted to detect a relationship between the first data file and the at least one further data file rendered by the application and to group the first tab pane information and the at least one further tab pane information in accordance with the detected relationship, such that the during display by the tab pane user interface control module (3302), the first tab pane information and the at least one further tab pane information are displayed in a grouped form corresponding to the relationship between the first data file and the at least one further data file rendered by the application. By way of yet another non-limiting example, the web engine module (3307) is further adapted to detect duplicity among the first data file and the at least one further data file being rendered by the application. The web engine module (3307) may include a web processing module (3308) for recognizing opening of multiple tabs in the application that provides the tabbed user interface. The web processing module (3308) may work in conjunction with a user interface processing module (3309) for realizing the background functions which are customary to a web browsing application. By way of a non-limiting example, while functionality is provided in the tab pane by tab pane user interface control module (3302), the user interface processing module (3309) may control a function on the corresponding data file based on an actuation of the functionality on the tab pane. Similarly, the web engine (3307) may include other customary modules such as Java Core module, a visual basic module, etc., all of which is collectively represented by 3310.

The tab pane user interface control module (3302) also allows for rearranging of the order of display of the tab pane information. In an alternative, the tab pane user interface control module (3302) rearranges the order of display of the tab pane information based on a calculated value of user interest. The system (3300) further comprises a browser application user interface module (3311) in operable inter-relationship with the tab pane user interface control module (3302) for rearranging an order of display of the corresponding data file by the application in response to rearranging of the order of display of the tab pane information. In the above paragraph it has been indicated that the web engine module (3307) is adapted to detect duplicity among the first data file and the at least one further data file being rendered by the application. The browser application user interface module (3311), based on the duplicity thus detected by the web engine module (3307), can close rendering of the duplicate data file.

In an embodiment of the disclosure, the system (3300) further comprises a platform or an operating system or drivers (3312) for operation of the application that provides the tabbed user interface.

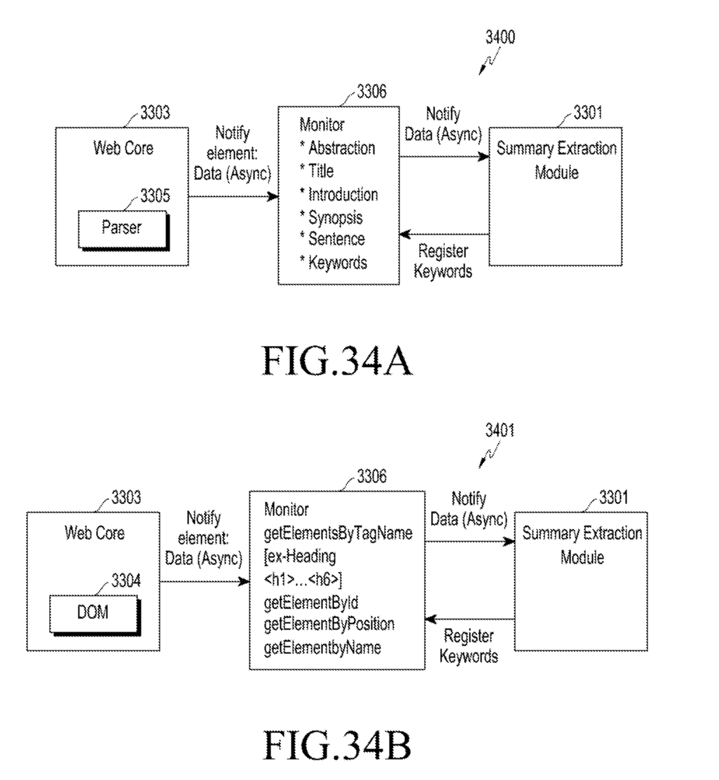

FIGS. 34A and 34B illustrate a block diagram of an extraction module according to various embodiments of the present disclosure.

Referring to FIGS. 34A and 34B, there is illustrated a schematic diagram showing summary extraction. In particular, FIG. 34A illustrates a schematic diagram (3400) pertaining to summary extraction using the parser, wherein the parser 3305 (which forms part of the web core (3303)) detects the data files which are being rendered and parses the text from the data file thus being rendered. The parsed data is then notified to the monitor (3306), which will in turn notify the same (after processing) to the summary extraction module (3301). The summary extraction module (3301) will then register the key words based on the notification for use by the tab pane user interface control module (not illustrated in FIGS. 34A and 34B). For example, the key words can be from any one of Abstract, Title, Introduction, Synopsis, Sentences and Words.

In the alternative, as illustrated in FIG. 34B which relates to a schematic diagram (3401) of summary extraction using the DOM structure, the DOM module (3304) (which forms part of the web core (3303)) will detect the DOM structure of the data files which are being rendered and will notify the same to the monitor 3306, which will in turn notify the same (after processing) to the summary extraction module (3301). The summary extraction module (3301) will then register the key words based on the notification for use by the tab pane user interface control module (not illustrated in FIGS. 34A and 34B). For example, the key words can be based on Tag Name, Identification information, Position information and Name information.

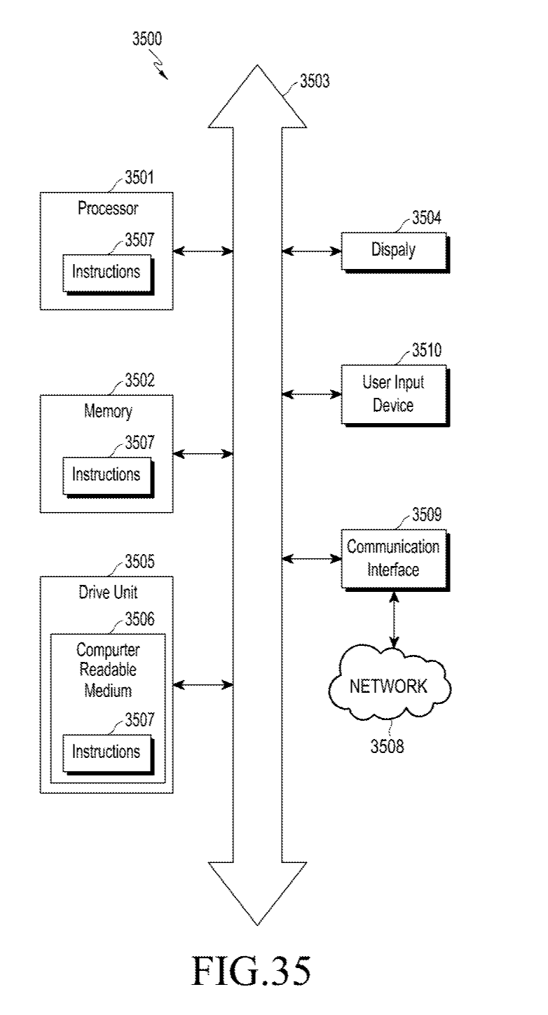

FIG. 35 illustrates a hardware configuration of a system in the form of a computer system according to an embodiment of the present disclosure.

Referring to FIG. 35, a typical hardware configuration of the system (3300) in the form of a computer system (3500) is shown. The computer system (3500) can include a set of instructions that can be executed to cause the computer system (3500) to perform any one or more of the methods disclosed. The computer system (3500) may operate as a standalone device or may be connected, e.g., using a network, to other computer systems or peripheral devices.

In a networked deployment, the computer system (3500) may operate in the capacity of a server or as a client user computer in a server-client user network environment, or as a peer computer system in a peer-to-peer (or distributed) network environment. The computer system (3500) can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. Further, while a single computer system (3500) is illustrated, the term “system” shall also be taken to include any collection of systems or sub-systems that individually or jointly execute a set, or multiple sets, of instructions to perform one or more computer functions.

The computer system (3500) may include a processor (3501), e.g., a central processing unit (CPU), a graphics processing unit (GPU), or both. The processor (3501) may be a component in a variety of systems. For example, the processor (3501) may be part of a standard personal computer or a workstation. The processor (3501) may be one or more general processors, digital signal processors, application specific integrated circuits, field programmable gate arrays, servers, networks, digital circuits, analog circuits, combinations thereof, or other now known or later developed devices for analyzing and processing data The processor (3501) may implement a software program, such as code generated manually (i.e., programmed).

The computer system (3500) may include a memory (3502), such as a memory (3502) that can communicate via a bus (3503). The memory (3502) may be a main memory, a static memory, or a dynamic memory. The memory (3502) may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory (3502) includes a cache or random access memory for the processor (3501). In alternative examples, the memory (3502) is separate from the processor (3501), such as a cache memory of a processor, the system memory, or other memory. The memory (3502) may be an external storage device or database for storing data. Examples include a hard drive, compact disc (CD), digital versatile disc (DVD), memory card, memory stick, floppy disc, universal serial bus (USB) memory device, or any other device operative to store data. The memory (3502) is operable to store instructions executable by the processor (3501). The functions, acts or tasks illustrated in the figures or described may be performed by the programmed processor (3501) executing the instructions stored in the memory (3502). The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system (3500) may or may not further include a display unit (3504), such as a liquid crystal display (LCD), an organic light emitting diode (OLED), a flat panel display, a solid state display, a cathode ray tube (CRT), a projector, a printer or other now known or later developed display device for outputting determined information. The display (3504) may act as an interface for the user to see the functioning of the processor (3501), or specifically as an interface with the software stored in the memory (3502) or in a drive unit (3505).

The computer system (3500) may also include a disk or optical drive unit (3505). The disk drive unit (3505) may include a computer-readable medium (3506) in which one or more sets of instructions (3507), e.g. software, can be embedded. Further, the instructions (3507) may embody one or more of the methods or logic as described. In a particular example, the instructions (3507) may reside completely, or at least partially, within the memory (3502) or within the processor (3501) during execution by the computer system (3500). The processor (3501) and the memory (3502) may also include computer-readable media as discussed above.

The present disclosure contemplates a computer-readable medium that includes instructions (3507) or receives and executes instructions (3507) responsive to a propagated signal so that a device connected to a network (3508) can communicate voice, video, audio, images or any other data over the network (3508). Further, the instructions (3507) may be transmitted or received over the network (3508) via a communication port or interface (3509) or using the bus (3503). The communication port or interface (3509) may be a part of the processor (3501) or may be a separate component. The communication port (3509) may be created in software or may be a physical connection in hardware. The communication port (3509) may be configured to connect with a network (3508), external media, the display (3504), or any other components in system (3500), or combinations thereof. The connection with the network (3508) may be a physical connection, such as a wired Ethernet connection or may be established wirelessly as discussed later. Likewise, the additional connections with other components of the system (3500) may be physical connections or may be established wirelessly. The network (3508) may alternatively be directly connected to the bus (3504).

The network (3508) may include wired networks, wireless networks, ethernet audio video bridging (AVB) networks, or combinations thereof. The wireless network may be a cellular telephone network, an 802.11, 802.16, 802.20, 802.1Q or worldwide interoperability for microwave access (WiMax) network. Further, the network (3508) may be a public network, such as the internet, a private network, such as an intranet, or combinations thereof, and may utilize a variety of networking protocols now available or later developed including, but not limited to transmission control protocol (TCP)/internet protocol (IP) based networking protocols.

Additionally, the computer system (3500) may include an input device (3510) configured to allow a user to interact with any of the components of system (3500). The input device (3510) may be a number pad, a keyboard, or a cursor control device, such as a mouse, or a joystick, touch screen display, remote control or any other device operative to interact with the computer system (3500).

In an alternative example, dedicated hardware implementations, such as application specific integrated circuits, programmable logic arrays and other hardware devices, can be constructed to implement various parts of the system (3500). Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for internet and other packet switched network transmission (e.g., TCP/IP, user datagram protocol (UDP)/IP, HTML, HTTP) may be used. Such standards are periodically superseded by faster or more efficient equivalents having essentially the same functions. Accordingly, replacement standards and protocols having the same or similar functions as those disclosed are considered equivalents thereof.

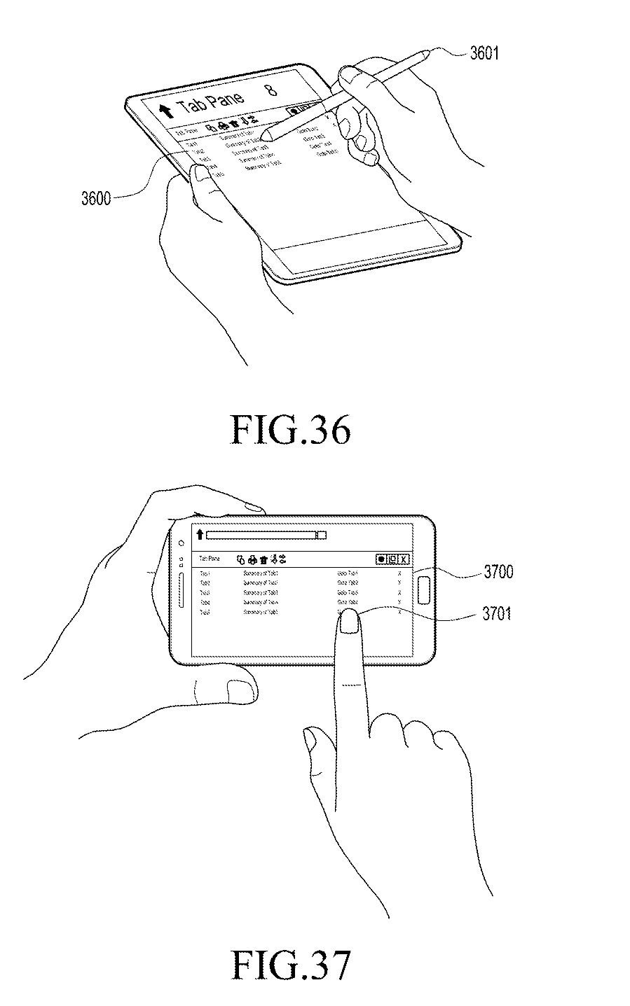

It may be noted that the method as described in the present disclosure can be implemented in a wide variety of electronic devices including but not limited to desktop computers, lap top computers, palm top computers, tabs, mobile phones, televisions, etc. Also, the user input can be received by the system using a wide variety of techniques including but not limited to using a mouse, a gesture input, a touch input, a stylus input, a joy stick input, a pointer input, etc. This is illustrated in FIGS. 36 to 39.

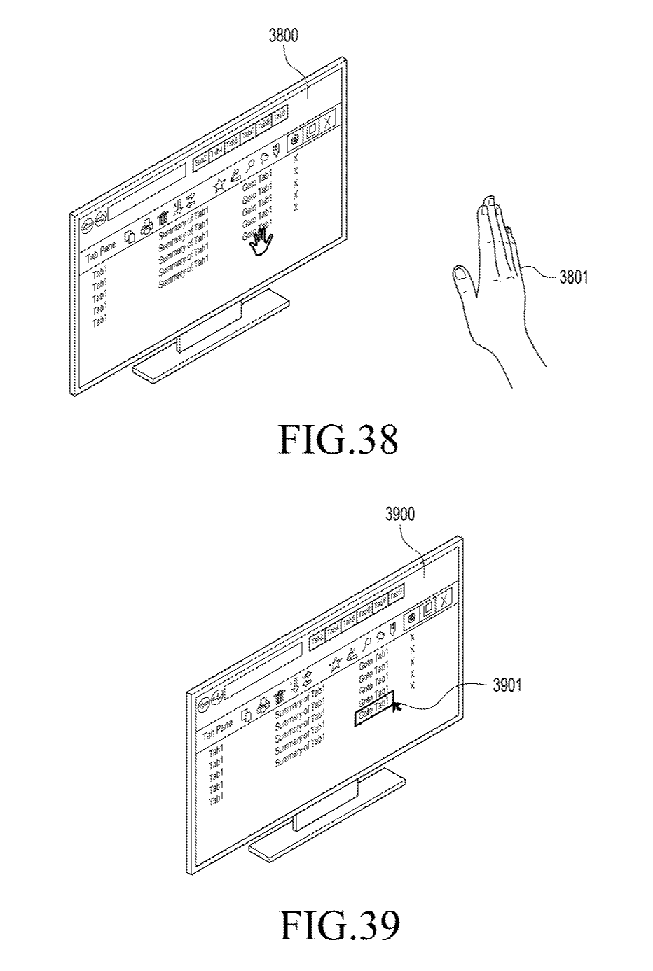

FIG. 36 illustrates implementation of a method in a handheld device with user input being received via a stylus device according to an embodiment of the present disclosure. FIG. 37 illustrates implementation of a method in a handheld device with user input being received via a touch screen according to an embodiment of the present disclosure. FIG. 38 illustrates implementation of a method in a television with user input being received in the form of a gesture input according to an embodiment of the present disclosure. FIG. 39 illustrates implementation of a method in a television with user input being received in the form of a pointing action according to an embodiment of the present disclosure.

Referring to FIG. 36, a handheld device (3600) implementing a method of the present disclosure is illustrated, the user input being received via a stylus device (3601). On the other hand, FIG. 37 illustrates a handheld device (3700) implementing the method of the present disclosure and the user input being received via a touch screen as provided on the handheld device (3701). In another illustration as presented in FIG. 38, a television (3800) is shown as implementing the method of the present disclosure and the user input being received in the form of a gesture input (3801). In another illustration as presented in FIG. 39, a television (3900) is shown as implementing the method of the present disclosure and the user input is illustrated as being received in the form of a pointing action (3901).

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method comprising:
extracting first tab pane information from a first data file, the first tab pane information corresponding to a first summary or first metadata of the first data file;
extracting second tab pane information from a second data file, the second tab pane information corresponding to a second summary or second metadata of the second data file; and
displaying, in a tab pane, the first tab pane information and the second tab pane information.

2. The method of claim 1, further comprising:
extracting first metadata from the first data file;
extracting second metadata from the second data file; and
determining satisfaction of the first metadata or the second metadata with at least one pre-determined criterion.

3. The method of claim 1, further comprising:
extracting from the first data file a first summary; and
extracting from the second data file a second summary, wherein the first summary or the second summary is based on:
a content contained in the corresponding data file; or
a metadata of the corresponding data file and a content contained in the corresponding data file.

4. The method of claim 1, further comprising:
detecting an order of rendering of the first data file and the second data file by the application; and
assigning the order thus detected to the extracted tab pane information such that the during display, the first tab pane information and the second tab pane information are displayed in an order corresponding to the order of rendering of the first data file and the second data file rendered by the application.

5. The method of claim 4, further comprising allowing for rearranging of the order of display of the tab pane information.

6. The method of claim 4, further comprising rearranging the order of display of the tab pane information based a calculated user interest value.

7. The method of claim 5, wherein, in response to rearranging the order of display of the tab pane information, the order of display of the corresponding data file by the application is re-arranged.

8. The method of claim 1, further comprising:
detecting a relationship between the first data file and the second data file rendered by the application; and
grouping the first tab pane information and the second tab pane information in accordance with the detected relationship, such that during the display, the first tab pane information and the second tab pane information are displayed in a grouped form corresponding to the relationship between the first data file and the second data file rendered by the application.

9. The method of claim 8, wherein the displaying of the first tab pane information and the second tab pane information in grouped form comprises displaying the first tab pane information and the second tab pane information in a hierarchical form.

10. The method of claim 1, further comprising detecting duplicity among the first data file and the second data file being rendered by the application.

11. The method of claim 10, wherein, in response to detecting duplicity, the tab pane information corresponding to a duplicate data file is deleted.

12. The method of claim 10, wherein, in response to detecting duplicity, the duplicate data file rendered by the application is closed.

13. The method of claim 1, wherein one of the first tab pane information and the second tab pane information is displayed visually differentiated based on a predetermined criterion.

14. The method of claim 1, wherein the tab pane is displayed in the form of a sub-window, a new tab, an overlay, a pop-up, or a side bar.

15. The method of claim 1, further comprising:
providing at least one functionality on the tab pane; and
controlling at least one of a function of the first data file and a function of the second data file based on actuation of the functionality on the tab pane.

16. A method comprising:
displaying first tab pane information on a tab pane, the first tab pane information corresponding to a summary or metadata of a first data file;
displaying second tab pane information on the tab pane, the second tab pane information corresponding to a summary or metadata of a second data file;
providing at least one functionality on the tab pane; and
controlling at least one of a function on the first data file and a function of the second data file based on actuation of the functionality on the tab pane.

17. The method of claim 16, wherein the controlling comprises controlling in a batch mode the at least one function of the first data file and the second data file based on actuation of the functionality on the tab pane.

18. The method of claim 16, wherein the controlling comprises controlling the at least one function of the first data file and the second data file based on a sequential actuation of a plurality of functionalities on the tab pane.

19. An electronic device comprising:
at least one processor; and
at least one memory storing one or more computer programs configured to be executed by the at least one processor, the one or more computer programs including instructions for:
extracting first tab pane information from a first data file, the first tab pane information corresponding to a summary or metadata of the first data file;
extracting second tab pane information from a second data file, the second tab pane information corresponding to a summary or metadata of the second data file; and
displaying in a tab pane, the first tab pane information and the second tab pane information.

20. The electronic device of claim 19, wherein the one or more computer programs further include instructions for recognizing opening of multiple tabs in the application that provides the tabbed user interface.
